(19) United States
(12) Patent Application Publication
(10) Pub. No.: US 2006/0000822 A1
(43) Pub. Date: Jan. 5, 2006

(54) Ceramic heater, wafer heating device using thereof and method for manufacturing a semiconductor substrate

(75) Inventor: Tsunehiko Nakamura, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/065,181

(22) Filed: Feb. 23, 2005

(30) Foreign Application Priority Data
Feb. 23, 2004 (JP) P 2004-046660
Mar. 29, 2004 (JP) P 2004-093935

(51) Int. Cl. A21B 1/00

(52) U.S. Cl. 219/409

(57) ABSTRACT

[Problems]In a ceramic heater comprising a heating face at one main side of a plate-shaped ceramic body and arc-shaped resistance exothermic body at another main side of it, there has been problems that when the rapid raising and lowering of temperature are repeated, cracks are generated between the plate-shaped ceramic body and the resistance exothermic body, thus a wafer cannot be uniformly heated, and the resistance exothermic body snaps not to heat the ceramic heater. And there has been problems that a difference of temperature in the wafer W can't be minimized because a space is formed between each of resistance exothermic bodies in each zone provided in a ceramic heater. [Means for Solving the Problems]In a resistance exothermic body made by electroconductive particles and insulating composition, the lumps of the insulating composition which were surrounded by a lot of the electroconductive particles are provided or pores are provided in the resistance exothermic bodies along an interface between the plate-shaped ceramic body and the resistance exothermic bodies. Further, in the pattern of resistance exothermic bodies, parallel arc-shaped belts with an approximately same width are provided so as to be formed in a nearly concentrical circle and so that a distance between a pair of arc-shaped ends situated on the same circle is smaller than a distance between arc-shaped belts which are adjacent to a radial direction.

### BACKGROUND OF THE INVENTION

The invention relates to resistance exothermic bodies comprising an electroconductive substance and an electroconductive paste forming the resistance exothermic bodies, for example, relates to a ceramic heater using the resistance exothermic body and the resistance exothermic bodies used at heating a wafer, and relates to a wafer heating device suitable for forming a thin film on a wafer such as a semiconductor wafer, a liquid crystal device or a circuit substrate and forming a resist film by drying and baking a resist solution which was coated on the wafer.

A heater for heating a semiconductor wafer (hereinafter, abbreviated as wafer) is used in the film forming processing of a semiconductor thin film, etching processing, the baking processing of a resist film and the like in the production process of a semiconductor manufacturing device.

A ceramic heater is widely used in accordance with requirements for the superior controllability of temperature, the fining of wiring of semiconductor elements and the improvement of accuracy of thermal treatment temperature of a wafer.

The ceramic heater was obtained by preparing the resistance exothermic body from an electroconductive body comprising a composite material of metal particles with glass. For example, a ceramic heater 71 equipped with a resistance exothermic body as shown in FIG. 11 is proposed in Reference 1 and Reference 2.

As the resistance exothermic body, there have been used those which were obtained by mixing glass frit with scaly noble metal particles and spherical noble metal particles to prepare a paste and printing and baking it.

Further, a plate-shaped ceramic body 72 and a case 79 were the main compositional elements of the ceramic heater 71 in which the resistance exothermic body was prepared from the electroconductive body. In the ceramic heater 71, the plate-shaped ceramic body 72 comprising nitride ceramics and carbide ceramics was fixed on the opening portion of a case 79 having a bottom consisting of a metal such as aluminum, with bolts 80 through adiabatic connecting members 74 made of a resin, and the upper side of the plate-shaped ceramic body was set as a wafer heating side 73 on which a wafer W is mounted, and the under side of the plate-shaped ceramic body 72 was designed so as to be provided with, for example, a concentric circular ring-shaped resistance exothermic body 75 as shown in FIG. 12.

Further, a power supply terminal 77 was soldered at the terminal portion of the resistance exothermic body 75, and the power supply terminal 77 was designed so as to be electrically connected with a lead wire 78 which was inserted into a hole 76 for pulling up the lead wire which was formed at the bottom portion 79a of the case 79.

Further, the plate-shaped ceramic body 72 was designed so as to be cooled by feeding a coolant from a nozzle 82 in a space surrounded by the plate-shaped ceramic body 72 and the case 79, circulating and discharging the coolant from a discharging hole 83.

By the way, in the ceramic heater 71, it is important to form a uniform film on the whole surface of the wafer W and to lessen the difference in temperature in a wafer face to uniform temperature distribution in order to homogenize the heating reaction condition of a resist film. Consequently, it have been carried out to adjust the resistance distribution of the belt-shaped resistance exothermic body 75 and to dividedly control the temperature of the belt-shaped resistance exothermic body 75 in order to lessen the temperature distribution of a wafer. Further, in case of a structure which generates heat withdrawal easily, it has been proposed to increase surrounding exothermic quantity.

Further, it is simultaneously required that transient time at heating and cooling the wafer is short and temperature at the transient time is further uniform. Further, it is required to change the setting temperature of the ceramic heater 71 for changing the heating temperature of the wafer, and it was required that time for heating and cooling the ceramic heater 71 was short.

In the Reference 3, a ceramic heater which formed a resistance exothermic body through a glass layer using an aluminum nitride sintered body for the plate-shaped ceramic body is disclosed.

However, there has been a fear that when power is applied to the resistance exothermic body to rapidly raise temperature using an electroconductive body as the resistance exothermic body and the ceramic heater is repeatedly cooled rapidly and raised rapidly in temperature, cracks are generated in the resistance exothermic body and function as the resistance exothermic body does not work.
[Reference 1] JP-A No. 2003-249332
[Reference 2] JP-A No. 2002-75598
[Reference 3] JP-A No. 2002-260832
[Reference 4] JP-A No. 2001-313249

### SUMMARY OF THE INVENTION

By the way, the ceramic heater 71 is heated to 200 to 300° C., in a ceramic heater and the wafer heating device 71 which is used for drying a photosensitive resin which was coated on the semiconductor wafer W, but since a processing time per one sheet is determined by the temperature raising time and cooling time of the ceramic heater 71, it is generally carried out to apply great electric power to rapidly heat it at raising temperature and to blow air at cooling to forcibly cool it. When heat cycle is repeatedly applied under such severe condition, stress is concentrated on the boundary between the plate-shaped ceramic body 72 forming the ceramic heater 71 and the electroconductive body being the resistance exothermic body 75 to generate minute peelings and when it proceeds further, cracks are generated to thereby vary heat transference between the portions with and without a generated peeling; therefore the thermal uniformity of the wafer heating face 73 is intercepted. As a result, the transient property at heating the wafer W is deteriorated, the temperature difference of the wafer W in the face is enlarged and the wafer W cannot be uniformly heated; therefore there has been a problem that properties are deteriorated such that the film thickness of the photosensitive resin is not uniform and the like. When the cracks are further developed, moisture in air is reacted with the aluminum nitride sintered body to generate ammonia gas and amine-base gas when the plate-shaped ceramic body is aluminum nitride; therefore there has been a problem that the gases impart bad influence to the photosensitive resin.

Namely, the thermal expansion coefficient of the aluminum nitride sintered body forming the plate-shaped ceramic body 72 is about 4.7×10⁻⁶/° C., and to the contrary, the thermal expansion coefficient of the resistance exothermic body 75 formed on the surface of the aluminum nitride sintered body is about 7.3×10⁻⁶/° C.; therefore there is a great difference between both bodies in the thermal expansion coefficient. Great stress is acted between the plate-shaped ceramic body 72 and the resistance exothermic body 75 by heat cycle which is repeatedly applied by the heating and cooling of the ceramic heater 71, and there has been a fear that stress is generated between the plate-shaped ceramic body 72 and the resistance exothermic body 75 by the stress and the resistance exothermic body 75 is deviated to be peeled and crack is generated.

Further, the property deterioration of the ceramic heater 71 by the thermal stress was also similar in the processing of film forming which is heated at higher temperature to be used and an etching processing step.

Accordingly, the first purpose of the present invention is to improve the durability of a wafer heating face from the structural side of the resistance exothermic body and design the thermal uniformity of the wafer heating face.

On the other hand, since spaces are formed between the mutual resistance exothermic bodies in the respective resistance exothermic body zones which were provided in the ceramic heater, there is a fear that the temperature difference of the respective resistance exothermic body zones is not adjusted, and it was extremely difficult that the temperature difference in the wafer W face is suppressed within 0.5° C.

Accordingly, the second purpose of the present invention is to design the thermal uniformity of the wafer heating face considering the arrangement pattern of the resistance exothermic body.

The first purpose of the present invention can be attained by a ceramic heater which comprises plate-shaped ceramic body having a pair of main surfaces, one of which is used for heating; and belt-shaped resistance exothermic bodies provided at the other surface or the inside of the plate-shaped ceramic body, wherein the belt-shaped resistance exothermic bodies comprises an insulating composition and electroconductive particles in a manner to make lumps of the insulating composition surrounded by a lot of the electroconductive particles.

Namely, according to the present invention, even if the resistance exothermic bodies are rapidly heated and rapidly cooled while applying electric power, cracks are not generated between the plate-shaped ceramic body and the resistance exothermic bodies and the wire of the resistance exothermic bodies does not snap by providing the resistance exothermic body with the lumps of the insulating composition which were surrounded by a lot of the electroconductive particles; therefore a ceramic heater superior in durability and a wafer heating device in which temperature difference in a wafer face is little and which is superior in durability for rapid temperature raise can be provided.

Further, the ceramic heater according to the present invention is characterized in that the mean diameter of the lumps of the insulating composition is 3-fold or more of the mean diameter of the electroconductive particles. The propagation of cracks generated by stress can be intercepted by the composition.

Further, the ceramic heater according to the present invention is characterized in that the mean diameter of the electroconductive particles is in a range of 0.1 to 5 μm and the mean diameter of the lumps of the insulating composition is in a range of 3 to 100 μm. When the mean particle diameter of the electroconductive particles is less than 0.1 μm, the electroconductive particles and the insulating composition cannot be adequately mixed. Further, when the mean particle diameter of the electroconductive particles exceeds 3 μm, the thermal expansion coefficient of the electroconductive particles is larger than that of the insulating composition; therefore since thermal stress at an interface is too large, there is a fear that the resistance exothermic bodies are destroyed by the thermal stress. Further, when the mean particle diameter of the insulating composition is 3 μm, durability for the thermal stress between the electroconductive body 5 and the plate-shaped ceramic body 2 is not lowered and when it is 100 μm or less, there is no fear that exothermic quantity is partially increased when power is applied to the electroconductive body 5.

Further, the ceramic heater according to the present invention is characterized in that particle having a larger thermal expansion coefficient than that of the insulating composition is provided internally in the lumps of the insulating composition. Thus, when particles are included in the lumps of the insulating composition, tensile stress is effected at the interface with the lumps and the strength of the lumps can be increased.

Further, the ceramic heater according to the present invention is characterized in that the particles having a large thermal expansion coefficient is of the same composition as the electroconductive particles. Powders comprising an insulating composition such as glass are simultaneously mixed with electroconductive particles to prepare a paste, it is formed on the plate-shaped ceramic body by a printing method and the like to be baked, and the resistance exothermic bodies can be easily formed.

Further, the ceramic heater according to the present invention is characterized in that an area rate occupied by the particles contained in the lumps of the insulating member is 10% or less at a cross-section. When the area rate exceeds 10%, there is generated a fear that mitigation effect for the thermal stress of particles becomes small and the strength of lumps cannot be enlarged.

Further, the ceramic heater according to the present invention is characterized in that it comprises plate-shaped ceramic body having a pair of main surfaces, one of which is used for heating; and belt-shaped resistance exothermic bodies provided at the other surface or the inside of the plate-shaped ceramic body, wherein pores are formed in the resistance exothermic bodies along an interface between the plate-shaped ceramic body and the resistance exothermic bodies.

Further, the ceramic heater according to the present invention is characterized in that it comprises plate-shaped ceramic body having a pair of main surfaces, one of which is used for heating; and belt-shaped resistance exothermic bodies provided at the other surface or the inside of the plate-shaped ceramic body, wherein pores are formed in the insulating layer along the interface between the plate-shaped ceramic body and the insulating layer.

Namely, according to the present invention, even if the resistance exothermic bodies are rapidly heated and rapidly cooled, cracks are not generated between the plate-shaped ceramic body and the resistance exothermic bodies and gas formation is inhibited by forming pores in the resistance exothermic bodies along an interface between the plate-shaped ceramic body and the resistance exothermic bodies or in the insulating layer along the interface between the plate-shaped ceramic body and the insulating layer; therefore a ceramic heater superior in durability and a wafer heating device in which temperature difference in a wafer face is little and which is superior in durability for rapid temperature raise can be provided.

Further, the ceramic heater according to the present invention is characterized in that the size of the pores is 0.05 to 50 μm. When the size of the pores is 0.05 to 50 μm, there is no fear that cracks are generated by the thermal stress at the junction interface.

Further, the ceramic heater according to the present invention is characterized in that the line density of the pores is 1000 to 500000/m at a section which is perpendicular to the main face of the plate-shaped ceramic body. When the line density of the pores is less than 1000/m, an effect of preventing the elongation of minute cracks generated at the junction interface is lessened. On the other hand, when the line density exceeds 1000 to 500000/m, the density of pores is too large. Accordingly, the thermal conductivity of the junction interface is lowered and the strength of the junction interface is lowered; therefore it is not preferable that it is difficult to uniformly heat a heated face and when the minute cracks are generated, the cracks are immediately extended to the whole junction interface.

Further, the second purpose of the present invention can be attained by a ceramic heater which comprises plate-shaped ceramic body having a pair of main surfaces, one of which is used for heating; and belt-shaped resistance exothermic bodies provided at the other surface or the inside of the plate-shaped ceramic body, wherein the resistance exothermic bodies comprise electroconductive particles and an insulating composition in a manner to make parallel arc-shaped belts having about the same width provided with arc-shaped ends connecting two belts so as to be formed in a nearly concentrical circle and to have a distance between a pair of arc-shaped ends situated on the same circle, which is smaller than a distance between arc-shaped belts which are adjacent to a radial direction.

Namely, according to the present invention, there can be obtained a ceramic heater in which temperature difference in a wafer face is little and the response property of temperature is superior, by providing that arc-shaped belts and arc-shaped ends having about the same width are nearly concentrically provided in succession, and a distance between a pair of arc-shaped ends which are situated on the same circumference is smaller than a distance between arc-shaped belts which are adjacent to a radial direction.

The ceramic heater according to the present invention is preferably a ceramic heater in which a distance between a pair of the arc-shaped ends which are situated on the same circle is 30% to 80% of the distance between the arc-shaped belts which are adjacent to a radial direction. Thereby, thermal uniformity of the heating face of the ceramic heater can be most enhanced.

Further, the ceramic heater according to the present invention is characterized in that a plural number of the belt-shaped resistance exothermic bodies can be independently heated, at least one of the resistance exothermic bodies having the distance between a pair of the arc-shaped ends which are situated on the same circle smaller than the distance between the arc-shaped patterns which are adjacent to a radial direction. The supplement of heat discharged much from the outer peripheral portion of the plate-shaped ceramic body is easy by forming the resistance exothermic bodies in such manner and the lowering of temperature around the wafer face can be prevented.

Further, the ceramic heater according to the present invention is characterized in that the resistance exothermic bodies comprise a zone of circular resistance exothermic body at a central portion and a zone of three concentric circular ring-shaped resistance exothermic bodies at the outside.

Further, the ceramic heater according to the present invention is characterized in that the outer diameter D1 of the resistance exothermic body zone at a central portion is 20 to 40% of the outer diameter D of the outermost peripheral resistance exothermic body zone, the outer diameter D2 of the resistance exothermic body zone at its outer side is 40 to 55% of the outer diameter D, and the inner diameter D3 of the resistance exothermic body zone at its outer side is 55 to 85% of the outer diameter D of the outermost peripheral resistance exothermic body zone.

The outer diameter D1 of the resistance exothermic body zone at a central portion is 20 to 40% of the outer diameter D of the outermost peripheral resistance exothermic body zone, the outer diameter D2 of the resistance exothermic body zone at its outer side is 40 to 55% of the outer diameter D, and the inner diameter D3 of the resistance exothermic body zone at its outer side is 55 to 85% of the outer diameter D of the outermost peripheral resistance exothermic body zone; therefore a wafer retaining member having little temperature difference and superior in the response property of temperature difference is obtained.

Further, the ceramic heater according to the present invention is characterized in that among the three circular ring-shaped resistance exothermic body zones, the innermost resistance exothermic body zone is an independent resistance exothermic body and equipped with a circular ring-shaped resistance exothermic body at its outside, the resistance exothermic body zone at its outside is two fan-shaped zones which were obtained by equally dividing a circular ring into 2 portions to a circumferential direction, and the resistance exothermic body zone at its outside is four fan-shaped zones which were obtained by equally dividing a circular ring into four portions to a circumferential direction.

The circular resistance exothermic body zone at a central portion and the resistance exothermic bodies with which circular rings at its outside are connected in series or in parallel are provided, two fan-shaped zones which were obtained by equally dividing a circular ring into 2 portions to a circumferential direction are composed at respectively confronting position in a circular ring at its outside, and four fan-shaped zones which were obtained by equally dividing a circular ring into four portions to a circumferential direction are composed at respectively confronting position in a circular ring at its further outside; therefore a wafer heating device having little temperature difference in a wafer face and a high thermal homogeneous property is obtained.

Further, the ceramic heater according to the present invention is characterized in that penetration holes are provided in the plate-shaped ceramic body between the resistance exothermic body zone at a central portion and ring-shaped resistance exothermic bodies at its outside.

Further, the ceramic heater according to the present invention is characterized in that the width of the belt of the outermost peripheral resistance exothermic body is smaller than the width of the belts of other resistance exothermic body zones at its inside.

Further, the ceramic heater according to the present invention is characterized in that the area ratio of the resistance exothermic bodies occupied in the outer contact circle is 5 to 30% of the area of the outer contact circle surrounding the resistance exothermic body zones.

Further, the ceramic heater according to the present invention is characterized in that one main side of the plate-shaped ceramic body in the above-mentioned ceramic heater is a wafer heating face on which a wafer is mounted.

Further, the present invention is a method of preparing a semiconductor substrate which comprises steps of providing a semiconductor wafer mounted on a wafer heating face of the wafer heating device; and
subjecting the semiconductor wafer to a semiconductor thin film treating, etching and resist film forming while the semiconductor wafer is heated on the wafer heating face. A semiconductor wafer with high performance can be made because a surface for heating a wafer can obtain a uniformity of heat by using the above-mentioned device for heating a wafer.

### DETAILED DESCRIPTION OF THE PREFERRED EMBODIMENTS

The embodiments of the present invention are illustrated below.

FIG. 1 is a section view showing one example of the ceramic heater 1 related to the present invention. One main side of a plate-shaped ceramic body 2 comprising ceramics in which silicon carbide or aluminum nitride is a main component is a wafer heating side 3 on which a wafer W is mounted, resistance exothermic bodies 5 are formed on another main side, electric power supply portions 6 which are electrically connected with the resistance exothermic bodies 5 are provided and electric power supply terminals 11 are connected with the electric power supply portions 6. A metal case 19 surrounding these power supply portions 6 and the like is fixed on another main side of the peripheral portion of the plate-shaped ceramic body 2 through connecting members 17.

Further, wafer lift pins 25 can move the wafer W up and down through holes penetrating the plate-shaped ceramic body 2 and mount and dismount the wafer W on the wafer heating side 3. Then, the electric power supply terminals 11 are connected with the electric power supply portions 6, electric power is externally supplied, and the wafer W can be heated while measuring the temperature of the plate-shaped ceramic body 2 with a temperature measuring element 27.

Further, the wafer W is retained in a condition in which it is floated from the wafer heating side 3 by wafer supporting pins 8 and the unevenness of temperature caused by one side hit of the wafer W is designed so as to be prevented. Further, when the resistance exothermic bodies 5 are divided into a plural number of zones, the surface temperature of the wafer W which was mounted on the wafer heating side 3 is designed so as to be uniform by supplying electric power to the power supply terminals 11 of respective power supply portions 6 by independently controlling the temperature of respective zones and adjusting electric power applied to the power supply terminal 11 so that the temperatures of respective temperature measuring elements 27 are respective set values.

The electric power supply portions 6 comprising a material such as gold, silver, palladium or platinum are formed at the resistance exothermic bodies 5, and conduction is secured by connecting the electric power supply portions 6 with the power supply terminals 11. The power supply terminals 11 and the electric power supply portions 6 are connected using methods such as soldering and waxing so far as the method can secure conduction.

(Resistance Exothermic Bodies Compounded with Lumps of Insulating Composition Surrounded by Electroconductive Particles)

The lumps of the insulating composition surrounded by electroconductive particles may be compounded in the resistance exothermic bodies, in the ceramic heater 1 related to the present invention.

The embodiment related to the present invention of the resistance exothermic bodies compounded with the lumps of the insulating composition surrounded by the electroconductive particles are illustrated below.

As shown in FIGS. 2 and 3, since the lumps 5a of the insulating composition are provided in the inside of the above-mentioned resistance exothermic bodies 5, peeling along an interface between the plate-shaped ceramic body 2 and the above-mentioned resistance exothermic bodies 5 is not generated, and the resistance exothermic bodies 5 do not snap. The lumps 5a of the insulating composition have found in the above-mentioned resistance exothermic bodies 5 that they have an effect of increasing the strength of the resistance exothermic bodies 5 and preventing fracture against the thermal stress of the joint interface between the plate-shaped ceramic body 2 and the resistance exothermic bodies 5 which is generated from minute difference in thermal expansion coefficients of the plate-shaped ceramic body 2 and the above-mentioned resistance exothermic bodies 5.

Hereat, the resistance exothermic bodies 5 being an electroconductive body are an article obtained by dispersing the electroconductive particles 5b in the insulating composition and the lumps 5a of the insulating composition which are surrounded by a lot of the electroconductive particles 5b are formed in it. The lumps 5a of the insulating composition are the insulating composition surrounded by the electroconductive particles 5b. The section of the resistance exothermic bodies 5 is mirror face-processed, a SEM photo is photographed, and the section can be shown with a polygonal shape which is internally brought in contact with the electroconductive particles 5b, by the region 5a surrounded on the photo by the electroconductive particles 5b.

Further, the diameter of a circle equivalent to the area of the polygon is referred to as the particle diameter of the lumps 5a of the insulating composition, and it was cleared that when the mean particle diameter is 3-fold or more and preferably 6-fold or more of the mean particle diameter of the electroconductive particles, it has an effect of intercepting the propagation of crack generated by stress. Further, a lot of the electroconductive particles 5b indicate that the electroconductive particles 5b are 5 or more, and the lumps 5a surrounded by the electroconductive particles 5b can be roughly represented as the lumps 5a which were surrounded by the electroconductive particles 5b which were continued at a length interval of 3-fold or less of the maximum diameter of the electroconductive particles 5b.

Further, the electroconductive particles 5b can use metals such as gold, platinum, palladium, iridium, rhodium, silver, copper and nickel. When these electroconductive particles 5b are approximately spherical, it is preferable because it is easy to mix with glass powders being the insulating composition. As the insulating composition, crystallized glass is preferable, and it is better that at least its portion contains a crystalline phase containing at least one kind of Zn, B and Si. As the kind of the crystal phase which is prepared or dispersed in glass, for example, Zn₂SiO₄, Zn₃B₂O₆, Zn₃(BO₃)₂, Zn(BO₂)₂, SiO₂ and the like can be mentioned.

Further, the mean particle diameter of the electroconductive particles 5b of the resistance exothermic bodies 5 is preferably 0.1 to 5 μm. When the mean particle diameter is less than 0.1 μm, the electroconductive particles cannot be adequately mixed with the insulating composition because the particle diameter of the electroconductive particles is too small. Further, when the mean particle diameter exceeds 3 μm, there is a fear that the thermal stress is too large and the resistance exothermic bodies 5 are destroyed by the thermal stress because the thermal expansion coefficient of the electroconductive particles is larger than that of the insulating composition.

Further, a 1500-fold SEM photo was photographed with a reflection electron microscope, two straight lines with a length of 30 μm were drawn, and the mean particle diameter of the electroconductive particles 5b was calculated by dividing the length of the electroconductive particles which the straight line crossed, by the crossed number.

Further, the mean particle diameter of the lumps 5a comprising the insulating composition is preferably 3 to 100 μm. When it is less than 3 μm, there is a fear that durability for the thermal stress between the resistance exothermic bodies 5 and the plate-shaped ceramic body 2 is lowered. Further, when it exceeds 100 μm, there is a fear that the lumps 5a are too large and the electric resistance of the resistance exothermic bodies 5 is partially increased; therefore there is a fear that when electric power is applied to the resistance exothermic bodies 5, exothermic quantity is partially increased.

Further, the mean particle diameter of the lumps 5a comprising the insulating composition selects a region which was surrounded by the electroconductive particles 5b, from the photo of a reflection electron microscope. A region in which a short diameter is 3-fold or more of the diameter of the electroconductive particles 5b is recognized as the lumps 5a of the insulating composition, straight lines with 70 μm were drawn on a 1500-fold reflection electron microscope photo, and it can be determined by dividing the total length of the lumps 5a which the straight lines crossed, by the number.

Further, it is preferable that particles 5c having a larger thermal expansion coefficient than the insulating composition exist internally in the inside of the lumps 5a of the insulating composition. Thus, when the particles 5c are contained in the lumps 5a, it is considered that tensile strength acts at the interface with the lumps 5a and the strength of the lumps 5a can be increased. When the particle diameter of the particles 5c is about 0.1-fold or less of the particle diameter of the lumps 5a, an effect of increasing the strength of the lumps 5a is great, which is preferable.

Further, the particles 5c may be the same composition as the above-mentioned electroconductive particles 5b. When the electroconductive particles 5b and the particles 5c are the same composition, powders comprising the insulating composition such as glass are simultaneously mixed with the electroconductive particles to prepare a paste, it is formed on the plate-shaped ceramic body 2 by a printing method and the like to be baked, and the resistance exothermic bodies 5 can be easily formed.

Further, for the resistance exothermic bodies 5 of the present invention, the number of the particles 5c having a larger thermal expansion coefficient than that of the insulating composition contained in the lumps 5a of the insulating composition are preferably 50 or less.

When the number of the particles 5c contained in the lumps 5a of the insulating composition is 50 or less in the SEM photo of a section of the resistance exothermic body 5, the effect of improving the strength of the lumps 5a by the particles 5c acts effectively, which is preferable. Because there is a fear that when it exceeds 50, the thermal stress by the particles 5c is too large and the strength of the lumps 5a is lowered. It is preferably 20 or less and further preferably 10 or less.

Further, the sectional area ratio of the particles 5c internally existing in the lumps 5a to the lumps 5a is preferably 10% or less. When it exceeds 10%, the mitigation effect to the thermal stress of the particles 5c is lowered and there occurs a fear that the strength of the lumps 5a cannot be enlarged. It is preferably 5% or less and further preferably 3% or less. Further, when it is 0.1% or more, the effect is observed, which is preferable.

Since the thermal stress is added between the plate-shaped ceramic body 2 and the resistance exothermic bodies 5 through the insulating layer 4 as shown in FIG. 4 also in the ceramic heater 1 in which the insulating layer 4 such as glass was formed on the plate-shaped ceramic body 2 and the resistance exothermic bodies 5 were formed on it, there is removed a fear that cracks are generated and peeled between the resistance exothermic bodies 5, the insulating layer 4 and the plate-shaped ceramic body 2, by providing the lumps 5a of the insulating composition in the resistance exothermic bodies 5 in like manner as the above-description. It is considered that this occurs because the existence of the lumps 5a of the insulating composition generates an action which absorbs and mitigates the thermal stress which is generated by the difference of thermal expansion coefficient between the plate-shaped ceramic body 2 and the resistance exothermic bodies 5.

Then, the preparation method of the lumps 5a of the insulating composition which is the characteristic of the present invention is described.

The resistance exothermic bodies 5 of the present invention provide the insulating composition with the electroconductive particles 5b and glass and ceramics are used as the insulating composition. Further, those having a little particle diameter are preferable as the insulating composition filling the surrounding of the electroconductive particles and the interface of the electroconductive particles and the lumps 5a of the insulating composition is preferably that the particle diameter of glass powder and ceramics powder as the insulating composition comprise large particles. Accordingly, the resistance exothermic bodies 5 can be formed by mixing the electroconductive particles with the powder of the insulating composition comprising two or more of particle groups as glass and ceramics powder.

The particle size distribution of the powder composing the insulating composition has preferably 2 or more of the maximum values, and it is preferable that the particle diameter indicating a larger maximum value among the particle diameter having 2 maximum values is 2-fold or more of the particle diameter indicating a smaller maximum value. 5-fold or more is further preferable.

Consequently, the electroconductive paste of the present invention comprising the insulating composition, the electroconductive particles and the organic binding material is characterized in that the maximum values of the particle diameter distribution of particles comprising the insulating composition and the electroconductive particles are 2 or more. The above-mentioned maximum values can be read from the graph of frequency and the particle diameter using a particle size measuring device. Further, the organic binding material can be composed of various organic binders, a plasticizer, a dispersant, an organic solvent and the like.

Further, in order to uniformly mix the powder comprising the insulating composition and the powder comprising the electroconductive particles, it is preferable that the mean particle diameter of the above-mentioned lumps 5a of the insulating composition is 1 to 30-fold of the mean particle diameter of the electroconductive particles. When the mean particle diameter of the insulating composition is less than 1-fold, the amount of a solvent is 30% by weight or more in order to uniformly mix the fine electroconductive particles having a diameter of 2 μm or less with the particles comprising the insulating composition to prepare a paste, the density of the paste is lowered, shrinkage quantity at baking is enlarged, which is nor preferable. Further, when the mean particle diameter of the electroconductive particles and the mean particle diameter of the above-mentioned insulating composition exceeds 30-fold of the mean particle diameter of the electroconductive particles, the insulating composition and the electroconductive particles are separated and hardly mixed, which is not preferable. 2 to 10-fold is further preferable, and 3 to 5-fold is more preferable. Among these electroconductive particles, it is preferable in particular because noble metals such as Au, Pd, Pt, Rh and Ir can prepare fine and nearly spherical powder.

Further, heat cycle that great electric power is applied to it to rapidly heat to a fixed temperature and air is purged on the surface of the heating face 3 and the counter side of the ceramic heater 1 to forcibly cool it at cooling is added to the ceramic heater 1, but in the ceramic heater 1 of the present invention, as shown in FIG. 5, it is composed that the glass layer 4b having an approximate thermal expansion coefficient with an aluminum nitride sintered body is provided between the resistance exothermic bodies 5 and the plate-shaped ceramic body 2 comprising the aluminum nitride sintered body which is covered with the oxide film 4a containing Al which is the portion of the insulating layer 4, and the oxide film 4a having a greatly different thermal expansion coefficient is sandwiched between the glass layer 4b and the aluminum nitride sintered body having an approximate thermal expansion coefficient. Thereby, stress acting on the oxide film 4a can be mitigated as a conventional ceramic heater having no glass layer 4b, and the oxide film 4a and the glass layer 4b can be strongly adhesive. Accordingly, even if the fore-mentioned heat cycle acted, it is prevented that cracks are generated at the boundary between the oxide film 4a and the glass layer 4b and the boundary between the glass layer 4b and the resistance exothermic body 5, therefore a long life ceramic heater can be provided.

By the way, in order to reveal such effect, it is preferable that glass in which the difference of the thermal expansion coefficient with the aluminum nitride sintered body forming a heater portion 30 is in a range of −3.0 to 3.0×10⁻⁶/° C. is used as the glass layer 4b, and the thickness T of the glass layer 4b is 2 to 300 μm.

Because when the thermal expansion coefficient of the glass layer 4b is less than the thermal expansion coefficient of the aluminum nitride sintered body over 3.0×10⁻⁶/° C., the effect of mitigating the stress acting on the oxide film 4a is lessened by sandwiching the oxide film 4a having a different thermal expansion coefficient with members having an approximate thermal expansion coefficient. Further, the difference of the thermal expansion coefficient with the oxide film 4a is too large and the oxide film 4a becomes fragile and the oxide film 4a is easily peeled by the heat cycle repeatedly added. To the contrary, when the thermal expansion coefficient of the glass layer 4b is larger than the thermal expansion coefficient of the aluminum nitride sintered body over 3.0×10⁻⁶/° C., the effect of mitigating the stress by sandwiching the oxide film 4a is small and when the surface of the resistance exothermic body 5 is forcibly cooled by air, cracks are easily generated at the outer peripheral portion of the resistance exothermic bodies 5.

Further, the reason why the thickness T of the glass layer 4b is 2 to 300 μm is that when the thickness T of the glass layer 4b is less than 2 μm, the glass layer 4b cannot be formed on the heater portion 30 at a uniform thickness and when the thickness T of the glass layer 4b exceeds 300 μm, great internal stress enough for warping the heater portion 30 is generated and the glass layer 4b is peeled during use.

Further, it is preferable that the flatness of the surface of the glass layer 4b forming the resistance exothermic bodies 5 is 300 μm or less. When the flatness exceeds 300 μm, it is difficult to form the resistance exothermic bodies 5 at a uniform thickness; therefore the unevenness of the resistance value of the resistance exothermic bodies 5 is generated.

On the other hand, the resistance exothermic bodies 5 formed on the glass layer 4b comprise glass containing at least one or more of metals or alloy thereof among Au, Ag, Pd, Pt, Rh and Ir and at least one of Zn, B and Si, and those in which the thermal expansion coefficient of the resistance exothermic bodies 5 is in a range of −0.5 to 3.0×10⁻⁶/° C. against the thermal expansion coefficient of the aluminum nitride sintered body which forms the heater portion 30 are preferable. The generation of cracks at preparation and use of the ceramic heater 1 is reduced and durability can be further improved by adjusting the difference of thermal expansion coefficients within the above-mentioned range.

Further, the property of glass forming the insulating layer 4 may be crystalline or amorphous, and it is preferable that thermal resistant temperature is 200° C. or more and the thermal expansion coefficient at a range of 0° C. to 200° C. is 1.0×10⁻⁶/° C. against the thermal expansion coefficient of ceramics composing the plate-shaped ceramic body 2. It is further preferable that glass having the thermal expansion coefficient of −5×10⁻⁷/° C. to +5×10⁻⁷/° C. is appropriately selected to be used. Namely, when glass having the thermal expansion coefficient out of the fore-mentioned range is used, the difference of the thermal expansion coefficient to that of ceramics forming the plate-shaped ceramic body 2 becomes too large; therefore defects such as crack and peeling at cooling after baking the glass are easily generated.

At this time, it is preferable that glass whose softening point is lower than the transfer point of glass forming the glass layer 4b is used as the glass contained in the resistance exothermic bodies 5, and it can be prevented by using the glass that the glass layer 4b is softened and deformed by thermal hysteresis at baking the resistance exothermic bodies 5 described later and bad influence is imparted to the resistance value distribution of the resistance exothermic bodies 5.

Further, it is preferable that glass containing at least one crystal among Zn₂SiO₄, Zn₃B₂O₆, Zn₃(BO₃)₂, Zn(BO₂)₂ and SiO₂ in its inside is used as the glass contained in the resistance exothermic bodies 5. Since these crystals have a little thermal expansion coefficient, they have an effect of lowering the thermal expansion coefficient of the resistance exothermic bodies 5 and even if cracks are generated in glass, the development of the cracks can be suppressed by the above-mentioned crystals; therefore the life time of the resistance exothermic bodies 5 whose wire snapped conventionally at about 10000 cycles in a heat cycle test of 50° C. to 350° C. can be elongated to 20000 cycles, and the long life ceramic heater 1 can be provided.

In particular, when crystals having a needle shape as their crystal structure are used, they exist in a condition in which narrow crystals are incorporated in glass; therefore the strength of the resistance exothermic body 5 can be further improved and it is effective.

As the method of containing at least one crystal among Zn₂SiO₄, Zn₃B₂O₆, Zn₃(BO₃)₂, Zn(BO₂)₂ and SiO₂ in the glass of the resistance exothermic body 5, they may be crystallized or dispersed in the glass.

For example, when they are prepared by crystallization, glass which contains at least one kind of Zn, B and Si which are the compositional components of the above-mentioned crystals is heated and melted, crystal nuclei are adequately prepared by retaining the melt glass at nearby temperature forming crystal nuclei for about one hour, and then they are raised to crystal growth temperature to prepare crystallized glass in the glass.

Further, it may be well to use a paste in which at least one powder of Zn₂SiO₄, Zn₃B₂O₆, Zn₃(BO₃)₂, Zn(BO₂)₂ and SiO₂ was mixed, together with glass powder and to mix them in glass by baking processing, other than crystallization.

Further, the fixation of crystal phase contained in the glass of the resistance exothermic bodies 5 can be identified by X-ray diffraction (manufactured by RIGAKUDENKI Co.), and the measurement of the transfer point of the glass layer 4b and the softening point of the glass in the resistance exothermic bodies 5 is carried out by measuring heat while raising temperature using a differential thermal analyzer. The intersection of an asymptote of the first endothermic shift portion of a base line is referred to as the transfer point of glass and the intersection of an asymptote at both sides of mild exothermic peak which appears thereafter is referred to as the softening point of glass.

Further, as the metal forming the resistance exothermic body 5, Au, Ag, Pd, Pt, Rh and Ir can be used. Among these, since Pt, Au or an alloy thereof migrates hardly, the deterioration of the resistance exothermic body 5 can be prevented and since Pt and Au are superior in oxidation resistance, life time in the heat cycle test at 50° C. to 350° C. can be elongated to 25000 cycles.

The mixing ratio of a metal to glass forming the resistance exothermic bodies 5 is good at a weight ratio of 40:60 to 80:20. Because when the mixing ratio of a metal to glass is smaller than 40:60, the amount of glass is too small; therefore the resistance exothermic bodies 5 is easily peeled. To the contrary, when the mixing ratio of a metal to glass is larger than 80:20, the content of a metal is too little; therefore unevenness is partially generated in volume inherent resistance value, the heating face 3 of the heater portion 30 cannot be uniformly heated and the wire snapping of the resistance exothermic bodies 5 is easily generated.

On the other hand, as the aluminum nitride sintered body forming the heater portion 30, when those having a high thermal expansion coefficient are preferably used, and for example, those which containing 1 to 9% by weight of a rare earth metal element compound such as Y₂O₃, Er₂O₃, Ce₂O₃ or Yb₂O₃ as a sintering aid using aluminum nitride as a main component are used, a thermal conductivity of 100 W/(m·K) or more and further 150 W/(m·K) or more can be obtained and preferably used as the heater portion 30.

As the procedure of forming the oxide film 4a containing Al on the surface of the aluminum nitride sintered body which forms the heater portion 30, the aluminum nitride sintered body is thermally treated at a temperature of 850° C. to 1200° C. for about 1 to 10 hours under oxidation atmosphere. The oxide film 4a comprising alumina can be prepared by oxidation under the condition.

Hereat, the reason why thermal processing temperature was set at 850° C. to 1200° C. is that when it exceeds 1200° C., the preparation speed of an oxide film is too rapid and cracks are easily generated at the oxide film 4a. To the contrary, when it is less than 850° C., the preparation of the oxide film 4a is bad and the whole surface of the aluminum nitride sintered body cannot be covered with the oxide film 4a.

The film thickness T of the oxide film 4a forming the surface of the aluminum nitride sintered body is good to be 0.05 to 5 μm. When the film thickness T of the oxide film 4a is less than 0.05 μm, the whole surface of the aluminum nitride sintered body is hardly covered with the oxide film 4a perfectly by oxidation; therefore the aluminum nitride sintered body reacts with moisture in air to generate ammonia gas and amine-base gas and the property of a photosensitive resin which was formed on a wafer W is deteriorated. To the contrary, when the film thickness T of the oxide film 4a exceeds 5 μm, the shrinkage of the surface of the oxide film 4a is large in comparison with the aluminum nitride sintered body forming the heater portion 30 at cooling after formation of the oxide film 4a (the thermal expansion coefficient of the aluminum nitride sintered body: 4.7×10⁻⁶/° C. (20° C. to 400° C.), the thermal expansion coefficient of the oxide film 4a comprising alumina: 7.3×10⁻⁶/° C. (20° C. to 400° C.)); therefore tensile strength acts always on the oxide film 4a caused by the difference of shrinkage and crack is generated in the resistance exothermic bodies 5 when thermal impact by the temperature raising and forcible cooling of the resistance exothermic body 5 is added.

Further, when the oxide film 4a containing Al is formed, those which pasted the oxide film 4a such as alumina and yttrium-aluminum-garnet (YAG) by a procedure such as a spattering method, a CVD method or a PVD method may be good other than a method of oxidizing the surface of the aluminum nitride sintered body. At least, the surface of the aluminum nitride sintered body is designed so as to be not exposed.

Further, aluminum nitride as the plate-shaped ceramic body 2 was illustrated as an example, but even if the oxide film 4a containing silicon carbide is used as the plate-shaped ceramic body, an effect similar as aluminum nitride is obtained.

Further, since the ceramic heater 1 of the present invention connects the connection member 17 in a ring so as to support the under face of periphery of the plate-shaped ceramic body 2, the diameter of the case 19 can be equalized with the diameter DP of the plate-shaped ceramic body 2 and the diameter of the plate-shaped ceramic body 2 can be enlarged. Accordingly, even if the wafer W with low temperature is mounted on a wafer heating face with high temperature, the temperature around the wafer W is not lowered and the periphery of the wafer W can be heated by heat accumulated at a non exothermic region of the periphery of the plate-shaped ceramic body 2.

Further, in the ceramic heater 1 of the present invention, as shown in FIG. 6, since the above-mentioned connection member 17 is connected in a ring-shape so as to surround the terminal face of periphery of the plate-shaped ceramic body 2, the leak of heat at the periphery portion of the plate-shaped ceramic body 2 is prevented and the temperature difference in the face of the wafer W can be lessened. In particular, since the terminal face of the periphery of the plate-shaped ceramic body 2 is brought in contact with the connection member 17, the diameter of the plate-shaped ceramic body 2 is lessened and the heat of the resistance exothermic bodies 5 is effectively supplied to the wafer W, which is preferable. Further, when the wafer W with low temperature is mounted on a wafer heating face with high temperature, a lot of heat is required to be supplied to the periphery of the wafer W; therefore a lot of heat is required to be accumulated to the periphery of the plate-shaped ceramic body 2, and the non exothermic region where the resistance exothermic body 5 does not exist around the plate-shaped ceramic body 2 is required as a region accumulating heat.

Further, it is necessary to lessen the temperature difference of the wafer W in a face at a normal time that the diameter of an outer contact circle of the resistance exothermic bodies 5 is larger by about 3 to 5% than the diameter of the wafer W. Accordingly, the diameter DP of the plate-shaped ceramic body 2 is preferably larger by about 4 to 17% than the diameter of the wafer W. Further, since the terminal face around the plate-shaped ceramic body 2 can be retained, the non exothermic region of the plate-shaped ceramic body 2 can be lessened. On the other hand, the heat capacity of the non exothermic region can be adjusted by enlarging the thickness of the plate-shaped ceramic body 2 at the non exothermic region in order to increase heat accumulation quantity at the non exothermic region.

It is further preferable that the diameter D of the outer contact circle of the plate-shaped ceramic body 2 is 90 to 99% of the diameter DP of the plate-shaped ceramic body 2.

When the diameter D of the outer contact circle C of the resistance exothermic body 5 is less than 90% of the diameter DP of the plate-shaped ceramic body 2, the non exothermic region is too large; therefore time for rapidly raising the temperature of a wafer and rapidly cooling it is enlarged and the temperature response property of the wafer W is inferior. Further, the diameter DP of the plate-shaped ceramic body 2 is enlarged, the size of the wafer W which can be uniformly heated becomes small in comparison with the diameter DP of the plate-shaped ceramic body 2, and the wafer heating efficiency for electric power for heating the wafer W is lowered. Further, since the plate-shaped ceramic body 2 is enlarged, the setting area of a wafer manufacturing apparatus is enlarged and it is not preferable that operation rate for the setting area of a semiconductor manufacturing apparatus which is required to carry out the maximum production at the minimum area is lowered.

When the diameter D of the outer contact circle C of the resistance exothermic body 5 is larger than 99% of the diameter DP of the plate-shaped ceramic body 2, the non exothermic region is too small; therefore when the wafer W with low temperature is mounted on a wafer heating face 3 with high temperature, temperature around the wafer W is lowered and there is a fear that the temperature of the wafer W cannot be raised in a condition in which the temperature difference of the wafer W in a face is little. The interval between the connection members 17 and the outer periphery of the resistance exothermic bodies 5 is small and heat is not homogeneously flown from to the connection members 17. In particular, heat is also flown from a minute portion in which the symmetry of the resistance exothermic bodies 5 of the outer periphery portion is damaged and lost and there is a fear that the temperature is lowered and the temperature difference of the wafer W in a face at a normal time is enlarged.

More preferably, the diameter D of the outer contact circle C of the resistance exothermic bodies 5 is 92 to 97% of the diameter DP of the plate-shaped ceramic body 2.

In particular, the plate-shaped ceramic body 2 and the outer form of the case 19 are about equal and in case of the ceramic heater 1 of FIG. 1 in which the case 19 supports the plate-shaped ceramic body 2 from an under side, the diameter D of the outer contact circle C of the resistance exothermic body 5 is 92 to 95% and preferably 93 to 95% of the diameter DP of the plate-shaped ceramic body 2 in order to lessen the temperature difference of the wafer W in a face.

On the other hand, in case of the ceramic heater of FIG. 6 in which the case 19 was connected so as to surround the terminal face around the plate-shaped ceramic body 2, the diameter D of the outer contact circle C of the resistance exothermic body 5 is 95 to 98% and preferably 96 to 97% of the diameter DP of the plate-shaped ceramic body 2.

Further, heat capacity can be adjusted by the width of the non exothermic region as described above, and on the other hand, since the heat capacity at the non exothermic region is enlarged by enlarging the thickness of the plate-shaped ceramic body 2 at the non exothermic region, the lowering of temperature around the wafer W can be also prevented.

Further, the ceramic heater 1 of the present invention was illustrated in examples that the case 19 was connected with the under face around the plate-shaped ceramic body 2 and the case was connected with the terminal face around the plate-shaped ceramic body 2, but it is needless to say that there is included the ceramic heater 1 in which both of the surrounding under face and the surrounding terminal face are simultaneously connected with the case 19, which is within the range of the above-mentioned purport.

Further, in order to effectively express such effect, it is preferable that the film thickness of the belt-shaped resistance exothermic bodies 5 is 5 to 70 μm.

When the film thickness of the belt-shaped resistance exothermic bodies 5 is lower than 5 μm, it is difficult to print the belt-shaped resistance exothermic body 5 in a uniform film thickness by a screen printing method. Further, when the thickness of the belt-shaped resistance exothermic body 5 exceeds 70 μm, the thickness of the belt-shaped resistance exothermic body 5 is large even if the ratio of an area which the belt-shaped resistance exothermic body 5 occupies is 50% or less to the outer contact circle C, and the rigidity of the resistance exothermic body 5 is enlarged. Because of influence by the extension and shrinkage of the belt-shaped resistance exothermic bodies 5 caused by the temperature change of the belt-shaped resistance exothermic bodies 5, the plate-shaped ceramic body 2 is deformed and it is difficult to print a uniform thickness by a screen printing; therefore there is a fear that the temperature difference of the surface of the wafer W happens to be enlarged. Further, the preferable thickness of the belt-shaped resistance exothermic bodies 5 is 10 to 30 μm.

Then, the other composition of the ceramic heater 1 of the present invention is illustrated. It is characterized in that the case 19 is provided with a nozzle 24 cooling the plate-shaped ceramic body 2 and the heat capacity of the case 19 is 0.5 to 3.0-fold of the heat capacity of the plate-shaped ceramic body 2.

When the heat capacity of the case 19 is lower than 0.5-fold of the heat capacity of the plate-shaped ceramic body 2, cooling gas jetted from the nozzle 24 hits on the plate-shaped ceramic body 2 and removes heat from the plate-shaped ceramic body 2; therefore the quantity stored in the case 19 of heat of the cooling gas heated is too little and the heat of the plate-shaped ceramic body 2 cannot be appropriately accumulated. Consequently, the effect of lowering the temperature of the plate-shaped ceramic body 2 is little.

When the heat capacity of the case 19 is exceeds 3.0-fold of the heat capacity of the plate-shaped ceramic body 2, the heat capacity of case 19 is too large; therefore the heat of the plate-shaped ceramic body 2 can be accumulated in the case 19 through the cooling gas, but when the plate-shaped ceramic body 2 is heated, radiation heat from the plate-shaped ceramic body 2 is excessively transmitted to the case 19 and there was a fear that the speed of raising temperature is lowered even if the plate-shaped ceramic body 2 is heated. The heat capacity of the case 19 is preferably 0.7 to 1.2-fold and further preferably 0.9 to 1.2-fold of the heat capacity of the plate-shaped ceramic body 2. The heat of the plate-shaped ceramic body 2 is transmitted to the case 19 through cooling gas jetted from the nozzle 24 by setting the heat capacity within the range and effectively discharged. In particular, when the heat capacity of the metal case is close to the heat capacity of the plate-shaped ceramic body 2, about the half of the heat of the plate-shaped ceramic body 2 is transmitted to the metallic case and radiated from the outer face of the metallic case; therefore it was grasped that the temperature of the plate-shaped ceramic body 2 is easily lowered. Since the heat of the plate-shaped ceramic body 2 heated can be effectively removed, the temperature of the plate-shaped ceramic body 2 can be rapidly lowered and the temperature can be rapidly raised at heating the plate-shaped ceramic body 2 by the resistance exothermic bodies 5.

In order to change the magnification of the heat capacity of the plate-shaped ceramic body 2 against the heat capacity of the case 19, it is preferable to adjust it by changing the heat capacity of the case 19. The reason is that the heat capacity of aluminum nitride is larger than that of silicon carbide by several % to about 10% in the plate-shaped ceramic body 2 having the same size made of silicon nitride and aluminum nitride, but since the outer from and thickness of the plate-shaped ceramic body 2 of the invention are about the same, it is difficult to largely change the heat capacity of the plate-shaped ceramic body 2. However, the case 19 can be changed to an appropriate heat capacity by adjusting the thickness of a metal plate of the case 19 and the depth of the case 19 and by changing a material.

Further, in order to shorten the temperature raising time and cooling time of the ceramic heater 1, it was cleared that when the ratio S/V of the surface area S (cm²) of the case 19 to the volume V (cm³) of the case 19 is 5 to 50 (1/cm), the plate-shaped ceramic body 2 can be further preferably and effectively heated and cooled.

When the ratio S/V is lower than 5 (1/cm), the ratio of the surface area S to the volume V of the case 19 is little; therefore the efficiency that heat absorbed from the surface of the case 19 is radiated to the outside of the case 19 is bad and heat is apt to remain in the case 19. When the plate-shaped ceramic body 2 is heated, radiated heat is easily absorbed in the case 19 and it becomes difficult to rapidly raise the temperature of the plate-shaped ceramic body 2.

When the ratio S/V exceeds 50 (1/cm), cooling gas which was jetted from the nozzle 24 and hit to the plate-shaped ceramic body 2 to remove heat is not effectively cooled by the case 19, the heat of the cooling gas is transmitted to the case 19, the temperature of the case 19 is rapidly raised, and the heat of the plate-shaped ceramic body 2 cannot be effectively absorbed; therefore there was a fear that cooling time until lowering the temperature of the whole plate-shaped ceramic body 2 was enlarged.

The ratio S/V is preferably 11 to 20 (1/cm) and further preferably 13 to 15 (1/cm).

Then, a specific method of adjusting the ratio S/V so as to be within the above-mentioned range is illustrated. In general, when the thickness of the metal plate of the case 19 is enlarged, the ratio S/V is lessened, and it is preferable that the thickness of the side wall of the case 19 is 0.5 to 3 mm and the thickness of a bottom plate is 1 to 5 mm. In addition, it is more preferable that the thickness of the side wall is 0.5 to 2 mm and the thickness of a bottom plate is 1 to 3 mm. Further, the unevenness is provided at the outer periphery of the case 19 and the surface of the case 19 is enlarged; therefore the ratio S/V can be adjusted so as to be within the above-mentioned preferable range.

Further, hereat, the case 19 indicates a metal part in which the outer surface excluding the plate-shaped ceramic body 2 and the connection member 17 among parts forming the outer surface of the ceramic heater 1 comprises a metal.

Further, the cooling gas jetted from the nozzles 24 is hit on the under face of the plate-shaped ceramic body 2, radially expanded along the under face of the plate-shaped ceramic body 2, collided with the case 19 and members installed on the case 19 to change a course, and discharged from discharge holes 23 of the under face 21 of the case 19 to the outside of the ceramic heater 1. Further, the cooling gas removes the heat of the plate-shaped ceramic body 2, transmits the portion of the heat to the case 19 and is discharged. The partial heat of the plate-shaped ceramic body 2 transmitted to the case 19 is efficiently radiated from the outside of the case 19. The cooling gas jetted from the nozzles 24 can efficiently remove the heat of the plate-shaped ceramic body 2 by being strongly collided with the under face of the plate-shaped ceramic body 2. The cooling gas heated is discharged while transmitting heat to the case 19, but in order to enhance the flow rate of the cooling gas jetted from the nozzles 24 to be efficiently discharged, it is preferable that the case has the discharge holes 23 equipped with 1000 to 3200-fold of the area S against the total area S1 of the opening portions 24a of the nozzles 24 which were installed in plurality.

When the area of S2 is 1000-fold or less against the total area S1 of the opening portions 24a of the nozzles 24, the discharge holes 23 are small; therefore it is not preferable that the jetting quantity of the cooling gas jetted from the nozzles 24 is decreased and the efficiency of cooling the plate-shaped ceramic body 2 is low.

Further, when the area of S2 exceeds 3200-fold or less against the total area S1 of the opening portions 24a of the nozzles 24, the quantity by which the heat of the cooling gas heated by the plate-shaped ceramic body 2 was transmitted to the case 19 is decreased and the effect of cooling the plate-shaped ceramic body 2 is lessened.

Consequently, in case of the discharge hole 23 equipped with the area S2 of 1000 to 3200-fold or less against the total area S1 of the opening portions 24a of the nozzles 24, the cooling gas is efficiently hit on the plate-shaped ceramic body 2, the cooling gas is circulated in space which the plate-shaped ceramic body 2 and the case 19 surround, and it can be discharged from the discharge hole 23. S2 is preferably 1500 to 2500-fold of S1. S2 is further preferably 1700 to 2300-fold.

Further, when the cooling gas is flown as the above-description, the pressure difference P between the space which the plate-shaped ceramic body 2 and the case 19 surround and its external space can be 50 to 13 kPa; therefore superior cooling property is obtained.

When the pressure difference P is 50 Pa or lower, the flow rate of the cooling gas is little and the plate-shaped ceramic body 2 cannot be cooled for a short time.

When the pressure difference P exceeds 13 kPa, internal pressure is great, the space which the plate-shaped ceramic body 2 and the metallic case surround is expanded, its volume is enlarged and there was a fear that the positions of the under face of the plate-shaped ceramic body 2 and the case 19 are deviated and the temperature distribution of a wafer mounted on the under face of the plate-shaped ceramic body 2 is changed.

The pressure difference P is preferably 100 Pa to 1 kPa and further preferably 200 Pa to 500 Pa.

Further, it is necessary to be designed that the resistance exothermic bodies 5 are arranged at a fixed distance from the wafer heating face 3 and the facing interval S is 5-fold or less of the thickness t of the plate-shaped ceramic body 2.

The facing interval S is preferably 0.5 mm or more in order to provide a large size wafer W exceeding a diameter of 200 mm so as to be uniformly heated to high temperature.

Hereat, as shown in FIGS. 7 and 8, the facing interval S can be shown by the diameter of the maximum circle which is brought in contact with the belt of the resistance exothermic body 5, among the outer contact circles of the resistance exothermic body 5.

When the above-mentioned facing interval S exceeds 5-fold of the plate thickness t of the plate-shaped ceramic body 2, temperature around the center of the interval S is lowered and there is a fear that cool spots are generated in the wafer W which was mounted on the wafer heating face 3 of the plate-shaped ceramic body 2. Further, when the interval S is lower than 0.5 mm, there occurs a fear that the belt and belt of the resistance exothermic body 5 are shorted by influence of the oozing of an ink and the like when the resistance exothermic bodies 5 are printed by a screen printing method, and the temperature difference of the wafer W in a face cannot be lessened.

Then, the resistance exothermic bodies 5 are heated by supplying electric power in the electric power supplying portions 6 and the wafer W on the wafer heating face 3 is heated through the plate-shaped ceramic body 2. According to the present invention, since the ceramic heater 1 is connected with the case 19 having a bottom through the connection members 17 which support the under face of the plate-shaped ceramic body 2 and operation can be carried out without losing the heat of the plate-shaped ceramic body 2 above requirement by the connection members 17 connected to the plate-shaped ceramic body 2; therefore the plate-shaped ceramic body 2 is uniformly heated for a short time effectively and the temperature of the wafer W can be uniformly heated.

Further, since the plate-shaped ceramic body 2 is formed by a silicon carbide sintered body or an aluminum nitride sintered body, Young's modulus of 200 GPa or more is large, deformation is little even if heat is added and the thickness of a plate can be thinned; therefore a temperature raising time for heating until a fixed processing temperature, a cooling time for cooling from a fixed processing temperature to nearby room temperature can be shortened and productivity can be enhanced, and since the plate-shaped ceramic body 2 has a thermal conductivity of 60 W/(m·K) or more, the joule heat of the resistance exothermic bodies 5 can be rapidly transmitted even if the thickness of a plate is thin.

Thus, when the heat capacity of the plate-shaped ceramic body 2 is lessened, the temperature distribution of the plate-shaped ceramic body 2 is deteriorated because of the heat absorption from the case 19 having a bottom. Accordingly, a composition that the case 19 having a bottom retains the plate-shaped ceramic body 2 at the outer peripheral portion is made.

(Resistance Exothermic Bodies Equipped with Pores)

In the ceramic heater according to the present invention, pores illustrated below may be compounded in the resistance exothermic bodies. The embodiment of the resistance exothermic bodies in which pores related to the present invention was compounded is illustrated.

To the ceramic heater 1 of the present invention, there is added heat cycle that great electric power is applied to the ceramic heater 1 to be rapidly heated to a fixed temperature, and at cooling, air is jetted on the surface of the counter side of the wafer heating face 3 of the ceramic heater 1 to be forcibly cooled. Since the ceramic heater 1 of the present invention provides the above-mentioned resistance exothermic bodies 5 with the pores 7 along an interface between the plate-shaped ceramic body 2 and the above-mentioned resistance exothermic bodies 5, it has found that it has an effect of mitigating the thermal stress of the joint interface between the plate-shaped ceramic body 2 and the resistance exothermic bodies 5 which is generated from minute difference in thermal expansion coefficients of the plate-shaped ceramic body 2 and the above-mentioned resistance exothermic bodies 5.

FIG. 13 (b) is a magnified view of the joint interface between the resistance exothermic bodies 5 of FIG. 13 (a) and the plate-shaped ceramic body 2. When the rapid temperature raising and rapid cooling of the ceramic heater 1 are repeated without the pores 7 shown in FIG. 13(b), the thermal stress is repeatedly generated on the above-mentioned joint interface; therefore there was fears that the temperature difference of the wafer W in a face which was placed on the wafer heating face 3 of the ceramic heater 1 on which cracks were generated is enlarged and the resistance exothermic bodies 5 is peeled not to be functioned as the ceramic heater 1.

Further, also in the ceramic heater 1 in which the insulating layer 4 such as a glass layer was formed on the plate-shaped ceramic body 2 as shown in FIG. 14(a) and the resistance exothermic bodies 5 were formed on it, there is no fear that cracks are generated between the insulating layer 4 and the plate-shaped ceramic body 2 and they are peeled, by providing the pores 7 on the above-mentioned insulating layer along the interface between the plate-shaped ceramic body 2 and the insulating layer 4 as shown in FIG. 14(b). It is considered that since the pores 7 exist at the joint interface, an effect of mitigating the thermal stress which is generated from the difference in thermal expansion coefficients of the plate-shaped ceramic body 2 and the insulating layer 4 is generated.

For the above-mentioned pores 7, the sizes of the pores 7 can be determined by the diameters of circles whose areas are equivalent to the areas occupied by the pores 7 in the section. When the size of the pores 7 is 0.05 to 50 μm, the above-mentioned thermal stress acts on the joint interface repeatedly and cracks are not generated at the joint interface. When the size of the pores 7 is lower than 0.05 μm, there is a fear that cracks are generated at the joint interface by the repeated thermal stress acting on the joint interface, and when the size of the pores 7 exceeds 50 μm, the pores 7 themselves become cause for generating cracks and an effect of suppressing the generation of cracks at the joint interface. The size of the pores 7 is preferably 3 to 20 μm and further preferably 5 to 15 μm. Hereat, the section between the plate-shaped ceramic body 2 and the insulating layer 4 or the resistance exothermic bodies 5 which is perpendicular to the main face of the plate-shaped ceramic body 2 is polished, all the pores of 0.5 mm or more on each of the photos of SEM photograph with 8×10 cm at 200, 500, 1000, 5000, 10000 and 100000-fold are taken out and the sizes of the pores 7 can be read as the diameters of circles equivalent to the occupied areas which the respective pores occupy.

Further, the average value of the sizes of the above-mentioned pores 7 is preferably 1 to 30 μm. All the pores of 0.5 mm or more on each of the photos of SEM photograph with 8×10 cm at 200, 500, 1000, 5000, 10000 and 100000-fold of the section which is about vertical to the insulating layer 4 are taken out, the diameters Di of circles equivalent to the occupied areas which the pores 7 having a real dimension of 0.05 μm or more are determined, and the average value of the sizes of the pores 7 can be determined as the average value of Di using a LUZEX image processing device and the like. When the average value of the sizes of the pores 7 is lower than 1 μm, an effect of mitigating the thermal stress is lessened, cracks are easily generated and expanded and durability is inferior when the heat cycle of the rapid temperature raising and rapid cooling is added to the ceramic heater 1. When the average value exceeds 30 μm, the expansion of cracks generated becomes fast and there is a fear that minute cracks are generated and the joint interface is immediately peeled and dropped.

Further, the pores 7 are preferably circular in the SEM photograph of the above-mentioned section. Even if cracks are generated, action preventing the expansion of cracks in the inner face of the pores 7 is effected when cracks cross the pores 7, and a role of preventing the expansion of cracks can be carried out.

Furthermore, when the resistance exothermic body 5 and the insulating layer 4 are formed on the plate-shaped ceramic body 2 of the present invention, the above-mentioned pores 7 are nearly linearly distributed along the joint interface, but the line density of the pores 7 distributed on straight lines is preferably 1000 to 500000/m.

Hereat, with respect to the line density, respective three photos of SEM photographs of the section of the joint interface between the plate-shaped ceramic body 2 and the resistance exothermic body 5 are photographed at a magnification of 200, 500, 1000, 5000 and 10000, and the number of the pores 7 of 0.5 mm or more on respective photos at a belt-shaped region with a length of 10 cm along the joint interfaces on the respective photos was divided by the real dimension equivalent to 10 cm to obtain numbers. The largest value among the numbers was referred to as the line density.

When the line density of the pores 7 is lower than 1000/m, it is not preferable that an effect of preventing the expansion of minute cracks which were generated at the joint interface is little. On the other hand, when the line density of the pores 7 exceeds 500000/m, it was cleared that since the density of the pores 7 is too large, the thermal conductivity of the joint interface is lowered, the strength of the joint interface is lowered, it becomes difficult to uniformly heat the wafer heating face 3, and it is not preferable that cracks are immediately spread over the whole joint interface when minute cracks are generated.

Further, in order to provide the pores 7 of the present invention along the interface between the plate-shaped ceramic body 2, the insulating layer 4 and the resistance exothermic bodies 5, fixed the pores 7 can be provided by forming the surface oxidation film of the plate-shaped ceramic body 2 comprising a nitride and a carbide in atmosphere having lower oxidation partial pressure than air and at lower temperature, and coating a foaming agent such as fine Si₃N₄ on the main side of the plate-shaped ceramic body 2 and forming the insulating layer 4 and the resistance exothermic bodies 5.

As mentioned above, the resistance exothermic bodies in which the lumps of the insulating composition surrounded by the above-mentioned electroconductive particles and pores were compounded may be applied to the ceramic heater with a conventional wiring pattern as shown in FIGS. 19 to 21, but when it is applied to the ceramic heater with the wiring patterns shown below (for example, wiring patterns shown in FIG. 16 or FIG. 18), the thermal uniformity of the ceramic heater can be improved.

(Wiring Pattern of Resistance Exothermic Bodies)

The ceramic heater 1 of the present invention is that the form of the resistance exothermic bodies 5 which were formed in the inside or on the surface of the plate-shaped ceramic body 2 is composed so that arc-shaped patterns 5i to 5p having about the same width as shown in FIG. 16 and folded small arc-shaped belts 5q to 5v are nearly concentrically provided in succession. Namely, the resistance exothermic bodies 5 comprise the arc-shaped belts 5i to 5p having different radii which were arranged so as to compose about concentric circles at about equal distance and the folded small arc-shaped belts 5q to 5v which connect the mutual arc-shaped belts 5i to 5p which are adjacent to a radius direction and form series circuits, and the terminal portions of the arc-shaped belts 5i to 5j are electric power supply portions 6. Accordingly, the arc-shaped belt 5i and arc-shaped belt 5j, the arc-shaped belt 5k and arc-shaped belt 5m, the arc-shaped belt 5n and arc-shaped belt 5o, and the arc-shaped belt 5p are arranged so as to compose respectively circles, and the respective circles are concentrically arranged; therefore when the resistance exothermic bodies 5 are exothermically heated, the temperature distribution of the wafer heating face 3 can be concentrically distributed from the center to its peripheral portion.

Further, since distances L4, L5 and L6 between the arc-shaped belts 5i and 5j, the arc-shaped belts 5k and 5m, the arc-shaped belts 5k and 5m and the arc-shaped belts 5n and 5o, and the arc-shaped belts 5n and 5o and the arc-shaped belt 5p which are adjacent to a radius direction are arranged at nearly equal intervals, exothermic quantities per a unit volume in the arc-shaped belts 5i to 5p can be equalized; exothermic unevenness to a radius direction in the wafer heating face 3 can be suppressed.

Further, it is important that respective distances L1, L2 and L3 between a pair of the folded small arc-shaped belt 5q and folded small arc-shaped belt 5r, the folded small arc-shaped belt 5s and folded small arc-shaped belt 5t, and the folded small arc-shaped belt 5u and folded small arc-shaped belt 5v which are situated on the same circumference are lessened in correspondence with the respective distances L4, L5 and L6 between the arc-shaped belts 5i to 5p which are adjacent to a radius direction.

Namely, in order to enhance the thermal uniformity of the wafer heating face 3, it is important that not only the exothermic quantities per a unit volume in the arc-shaped belts 5i to 5p, but also that in the folded small arc-shaped belts 5q to 5v are also equalized. Normally, it is designed that the distances L1, L2 and L3 between a pair of the folded small arc-shaped belt 5q to 5v which are situated on the same circumference are the same distances L4, L5 and L6 between the arc-shaped belts 5i to 5p which are adjacent to a radius direction. However, in such a pattern form, since the exothermic density around the folding portions between the arc-shaped belts 5i to 5p and the folded small arc-shaped belts 5q to 5v is lessened, temperature at the outside of the folding portions is lowered, the temperature difference of the wafer W in a face is enlarged and the thermal uniformity is damaged. To the contrary, the present invention composes that since the respectively corresponding distances L1, L2 and L3 between the folded small arc-shaped belts 5q to 5v which are situated on the same circumference are smaller than the distances L4, L5 and L6 between the arc-shaped belts 5i to 5p which are adjacent to a radius direction, exothermic quantities of the folding portions P5 are supplemented by exothermic from the corresponding folded small arc-shaped belts 5q to 5v, and the temperature lowering of the folding portions P5 can be suppressed; therefore the temperature difference of the wafer W in a face mounted on the wafer heating face 3 can be lessened and the thermal uniformity can be enhanced.

In particular, when the distances L1, L2 and L3 between a pair of the folded small arc-shaped belt 5q to 5v which are situated on the same circumference are 30% to 80% of the respectively corresponding distances L4, L5 and L6 between the arc-shaped belts 5i to 5p which are adjacent to a radius direction, the thermal uniformity in the wafer heating face 3 can be enhanced. Further preferably, L1, L2 and L3 are 40 to 60% of the respectively corresponding L4, L5 and L6.

Further, since the resistance exothermic bodies 5 of the present invention comprise the arc-shaped belts 5i to 5p and the folded small arc-shaped belts 5q to 5v, there is no fear that excessive stress acts at the edge portions in comparison with a conventional rectangular folding resistance exothermic body, there is little fear that the plate-shaped ceramic body 2 and the resistance exothermic body 5 are damaged even if the temperature of the ceramic heater 1 is rapidly raised and lowered, and the ceramic heater 1 with high reliability can be provided.

Further, when the above-mentioned resistance exothermic bodies 5 were buried in the plate-shaped ceramic body, the effect is great and when the belt-shaped resistance exothermic bodies 5 are provided at another main side of the plate-shaped ceramic body 2, similar effect is also observed. In particular, when the belt-shaped resistance exothermic bodies 5 are formed on another main side, it is preferable that an effect of preventing the damage of the plate-shaped ceramic body 2 and the resistance exothermic bodies 5 is great when the insulating layer which was coated on the resistance exothermic bodies 5 was formed.

Further, the above-mentioned resistance exothermic bodies comprise a plural number of exothermic bodies which can be concentrically heated, and is characterized in that the interval of the belt of the concentrically outermost peripheral resistance exothermic body is smaller than the interval of the belt of the concentrically resistance exothermic body excluding the concentrically outermost peripheral resistance exothermic body. It is more preferable because the supplement of heat which is radiated much from the outer peripheral portion of the plate-shaped ceramic body 2 becomes easy by forming the resistance exothermic bodies 5 in such manner and the temperature lowering around the wafer W face can be prevented.

Further, the ceramic heater 1 of the present invention is preferably divided to the three concentrically circular ring-shaped resistance exothermic body zones 4 corresponding to the wafer heating face 3 of the wafer W. Atmosphere around the wafer W, the wall face facing the wafer W and the flow of gas influence the uniform heating of the surface of the disc-shaped wafer W, but it is designed so that the surrounding of the wafer W, the facing face at the upper side and the flow of atmospheric gas are centrically symmetric against the wafer W. The ceramic heater 1 which was matched to the above-mentioned centrally symmetric environment against the wafer W is necessary for uniformly heating the wafer W, and it is preferable that the wafer heating face 3 is divided in central symmetry to form the resistance exothermic body zones.

In particular, the concentrically circular ring-shaped resistance exothermic body zones are preferably three for uniformly heating the surface temperature of the wafer W of 300 mm or more.

FIG. 17 (a) shows the resistance exothermic body zones 4 of the present invention. The resistance exothermic body zones 4 are equipped with a plural number of the resistance exothermic body zones 4 at one side of the plate-shaped ceramic body 2 and equipped with a circular resistance exothermic body zone 4a at the central portion, and resistance exothermic body zones 4b and 4cd and a resistance exothermic body zone 4eh in the three concentrically circular rings at its outside. The resistance exothermic bodies 5 are divided corresponding to the four resistance exothermic body zones in order to improve the thermal uniformity of the wafer W.

Further, the outer diameter D1 of the resistance exothermic body zone 4a at the central portion of the ceramic heater 1 of the present invention is 20 to 40% of the outer diameter D of the resistance exothermic body zone 4eh at the outer peripheral portion. The outer diameter D2 of the resistance exothermic body zone 4bc at its outside is 40 to 55% of the outer diameter D of the resistance exothermic body zone at the outer peripheral portion. The inner diameter D3 of the resistance exothermic body zone at the outermost periphery is 55 to 85% of the outer diameter D of the resistance exothermic body zone at the outermost periphery. Thereby, the temperature difference of the wafer W in a face can be preferably lessened.

Further, the outer diameter D of the resistance exothermic body zone 4eh at the outer peripheral portion is the diameter of the outer contact circle surrounding the resistance exothermic body 5eh composing the resistance exothermic body zone 4eh, viewed by a projection plane parallel to another main side of the plate-shaped ceramic body 2. Further, similarly, the outer diameter D2 of the resistance exothermic body zone 4b is the diameter of the circle which is externally brought in contact with the resistance exothermic body 5b composing the resistance exothermic body zone 4b. Further, D3 is the diameter of the circle which is internally brought in contact with the resistance exothermic body 5cd. Further, the outer contact circle can be determined along the concentric arc excluding the projection portion of the resistance exothermic body which is connected with the electric power supply portions.

When the outer diameter D1 is less than 20%, the outer diameter D of the resistance exothermic body zone 4a at the central portion is too small; therefore even if the exothermic quantity of the resistance exothermic body zone 4a is large, there is a fear that the temperature of the central portion of the resistance exothermic body zone 4a is not raised and the temperature at the central portion is lowered. Further, when the outer diameter D1 exceeds 40%, the outer diameter of the resistance exothermic body zone 4a at the central portion is too large; therefore there is a fear that the temperature of the peripheral portion of the resistance exothermic body zone 4a is raised when the temperature at the central portion is raised and the temperature at the peripheral portion of the resistance exothermic body zone 4a is too high. Further, the outer diameter D1 is preferably 20 to 30% of D and the outer diameter D1 is further preferably 23 to 27% of D. Thereby, the temperature difference of the wafer W in a face can be further lessened.

Further, when the outer diameter D2 is less than 40% of the outer diameter D, the peripheral portion of the ceramic heater 1 is easily cooled; therefore there was a fear that when the exothermic quantity of the resistance exothermic body zone 4cd is increased for preventing the lowering of temperature around the wafer W, the temperature of the inside of the resistance exothermic body zone 4cd nearby the center of the wafer W is heightened, and the temperature difference of the wafer W in a face was enlarged. Further, when the outer diameter D2 exceeds 55% of the outer diameter D, there was a fear that even if the exothermic quantity of the resistance exothermic body zone 4cd is increased for preventing the lowering of temperature around the wafer W, the temperature of the resistance exothermic body zone 4cd is heightened, but the influence of the lowering of temperature around the wafer W reaches at the resistance exothermic body zone 4b, and the temperature of the outside of the resistance exothermic body zone 4b is lowered. The outer diameter D2 is preferably 41 to 53% of the outer diameter D and further preferably 43 to 49%. Thereby, the temperature difference of the wafer W in a face can be further lessened.

Further, when the outer diameter D3 is less than 55% of the outer diameter D, the peripheral portion of the ceramic heater 1 is easily cooled; therefore there was a fear that when the exothermic quantity of the resistance exothermic body zone 4eh was increased for preventing the lowering of temperature around the wafer W, the temperature of the inside of the resistance exothermic body zone 4eh nearby the center of the wafer W was heightened, and the temperature difference of the wafer W in a face was enlarged. Further, when the outer diameter D3 exceeds 85% of the outer diameter D, there was a fear that even if the exothermic quantity of the resistance exothermic body zone 4eh is increased for preventing the lowering of temperature around the wafer W, the temperature of the resistance exothermic body zone 4eh is heightened, but the influence of the lowering of temperature around the wafer W reaches at the resistance exothermic body zone 4cd, and the temperature of the outside of the resistance exothermic body zone 4cd is lowered. The outer diameter D3 is preferably 65% to 85% of the outer diameter D and further preferably 67 to 70%. Thereby, the temperature difference of the wafer W in a face can be further lessened.

Further, as described above, it was cleared that the ceramic heater 1 comprising a plural number of the resistance exothermic bodies 5 can rectify fine asymmetry at left and right and up and down caused by the surrounding environment and the unevenness of thickness of the symmetric exothermic body and the temperature difference of the wafer W in a face can be further lessened.

FIG. 17 (b) shows one example of the resistance exothermic body zones 4 of the present invention. Among three of the circular ring-shaped resistance exothermic body zones 4b, 4cd and 4eh, the innermost resistance exothermic body zone 4b is a resistance exothermic body zone 4b comprising a circular ring. The resistance exothermic body zone 4cd at its outside is two fan-shaped resistance exothermic body zones 4c and 4d which were made by equally dividing a circular ring into two portions to a circumferential direction. The resistance exothermic body zone 4eh at its outside comprises four fan-shaped resistance exothermic body zones 4e, 4f, 4g and 4h which were made by equally dividing a circular ring into four portions to a circumferential direction. They are preferable for uniforming the surface temperature of the wafer W.

The respective resistance exothermic body zones 4a to 4g of the above-mentioned ceramic heater 1 can be exothermically heated independently, and it is preferable that the resistance exothermic bodies 5a to 5g are provided corresponding to the respective resistance exothermic body zones 4a to 4g.

However, the zones 4a and 4b are connected in parallel or in series to be able to be controlled as one circuit unless a setting position which is also the external environment of the ceramic heater 1 is frequently changed. The composition is preferable because since a fixed interval can be set between the zones 4a and 4b, penetration holes to which lift pins for lifting up the wafer W are penetrated can be set.

Further, the circular ring-shaped resistance exothermic body zones 4cd and 4eh are respectively divided into 2 or 4 to a radiation direction, but it is not limited to this.

The boundary line of the resistance exothermic body zones 4c and 4d of FIG. 17 (b) is a straight line, but it is not always required to be a straight line, but may be a wave line. It is preferable that the resistance exothermic body zones 4c and 4d are a central symmetry against the center of the concentric resistance exothermic body zones.

Similarly, the respective boundary lines of the resistance exothermic body zones 4e and 4f, 4f and 4g, 4g and 4h, and 4h and 4e are not always required to be a straight line, but may be a wave line. It is preferable that they are a central symmetry against the center of the concentric resistance exothermic body zones.

The above-mentioned respective the resistance exothermic bodies 5 are formed by a printing method and the like and the belts of the resistance exothermic bodies 5 are preferably formed at a width of 1 to 5 mm and a thickness of 5 to 50 μm. When a printing plane printed at once is large, there occurs a fear that the thickness of printing is not constant according to difference in pressure between squeegee and a screen at the left and right and back and forth of the printing plane. In particular, there was a fear that when the sizes of the resistance exothermic bodies 5 are large, the thicknesses at the left and right and back and forth of the resistance exothermic bodies 5 are different and the exothermic quantity designed is uneven. When the exothermic quantity is uneven, it is not preferable because the temperature difference of the wafer W in a face is enlarged. It was cleared that the division of the respective resistance exothermic bodies 5 having a large outer diameter comprising one resistance exothermic body is effective for preventing the unevenness of temperature which is generated from the unevenness of the thickness of the resistance exothermic body.

Accordingly, the concentrically circular ring-shaped resistance exothermic body zone 4cd excluding the central portion of the wafer heating face 3 of the wafer W is divided into two portions to left and right, and the larger circular ring-shaped resistance exothermic body zone 4eh is divided into 4 portions. Thereby, the printing size of the resistance exothermic bodies 5 placed in the resistance exothermic body zones 4 can be lessened; therefore the thickness of the respective portions of the resistance exothermic bodies 5 can be uniformed and further, the fine temperature difference of the back and forth and left and right of the wafer W is rectified and the surface temperature of the wafer W can be uniformed. Furthermore, long grooves can be also formed and adjusted by laser beam and the like along the resistance exothermic bodies in order to finely adjust the resistance values of the belts of the respective resistance exothermic bodies 5.

Further, the patters of the resistance exothermic bodies 5a, 5b, 5c, 5d, 5e, 5f, 5g and 5h shown in FIG. 18 comprise folded patterns respectively.

Further, the ceramic heater 1 of the present invention is a ceramic heater 1 equipped with the resistance exothermic bodies 5 on one main side of the plate-shaped ceramic body 2, and as shown in FIG. 18, the resistance exothermic bodies 5e, 5f, 5g and 5h which are situated at the outer peripheral portion of the plate-shaped ceramic body 2 are preferably that the site which is far from the center of the plate-shaped ceramic body 2 comprises the concentrically circular ring-shaped belts 51 and the small arc-shaped belts 52 which are linking patterns linked with these in series. It is preferable that they comprise the electric power supply portions 6 which supply electric power to the resistance exothermic bodies 5 and the metal case 19 which surrounds said electric power supply portions 6 and are equipped with the wafer heating face at another main side of the plate-shaped ceramic body 2, and viewed by a projection plane parallel to another main side of the plate-shaped, the diameter D of the outer contact circle C of the resistance exothermic bodies 5 is 90 to 97% of the diameter DP of the plate-shaped ceramic body 2.

When the diameter D of the outer contact circle C of the resistance exothermic bodies 5 is less than 90% of the diameter DP of the plate-shaped ceramic body 2, a time for rapidly raising the temperature of a wafer and rapidly cooling it is elongated and the temperature response property of the wafer W is inferior. Further, in order to uniform the surface temperature of the wafer W so as not to lower the temperature of the peripheral portion of the wafer W, the diameter D is preferably about 1.02-fold of the diameter of the wafer W; therefore the diameter DP of the plate-shaped ceramic body 2 is large for the size of the wafer W, the size of the wafer W which can be uniformly heated is small in comparison with the diameter DP of the plate-shaped ceramic body 2, and the heating efficiency which heats the wafer W is deteriorated for electric power supplied to heat the wafer W. Further, since the plate-shaped ceramic body 2 is larger, the setting area of a wafer manufacturing apparatus is enlarged and it is not preferable that the operation rate to the setting area of a semiconductor manufacturing apparatus which is required to carry out the maximum production at the minimum setting area is lowered.

When the diameter D of the outer contact circle C of the resistance exothermic bodies 5 is larger than 97% of the diameter DP of the plate-shaped ceramic body 2, the interval between the contact member 17 and the outer periphery of the resistance exothermic bodies 5 is small, heat from the outer periphery of the resistance exothermic bodies 5 flows to the contact member 17, in particular, heat flows also from a portion in which the arc-shaped pattern 51 in contact with the outer contact circle C at the outer periphery portion does not exist, and the arc-shaped pattern 51 at the outer peripheral portion is bent to the central portion of the plate-shaped ceramic body 2; therefore there is a fear that the temperature of portions P in which the arc-shaped pattern 51 does not exist along the outer contact circle C surrounding the resistance exothermic bodies 5 is lowered and the temperature difference of the wafer W in a face is enlarged. The diameter D of the outer contact circle C of the resistance exothermic bodies 5 is more preferably 92 to 95% of the diameter DP of the plate-shaped ceramic body 2.

Further, as shown in FIG. 1, when the outer diameters of the plate-shaped ceramic body 2 and the metal case 19 are nearly same and the metal case 19 supports the plate-shaped ceramic body 2 from under side, the diameter D of the outer contact circle C of the resistance exothermic bodies 5 is 91 to 95% of the diameter DP of the plate-shaped ceramic body 2 in order to lessen the temperature difference of the wafer W in a face and further preferably 92 to 94%.

Further, the ceramic heater 1 of the present invention is equipped with the arc-shaped pattern 51 which is brought in contact with the outer contact circle C of the resistance exothermic bodies 5, for example, of FIG. 18 and the small arc-shaped belts 52 which are linking patterns linked with the arc-shaped belts 51 in series, and it is preferable that the interval L1 of a vacant region having no arc-shaped pattern at the outer contact circle C is smaller than the difference (hereinafter, abbreviated as LL) between the diameter DP of the plate-shaped ceramic body and the diameter D of the outer contact circle C. When the interval L1 is larger than LL, there is a fear that heat at the vacant region P flows into the outer peripheral portion of the plate-shaped ceramic body and the temperature of the vacant regions P is lowered. However, when the interval L1 is smaller than LL, the temperature of the vacant region P is hardly lowered, the one portion of the peripheral portion of the wafer W mounted on the wafer heating face 3 of the plate-shaped ceramic body 2 is not lowered and the temperature difference of the wafer W in a face is preferably little.

It is necessary to raise the temperature of the vacant region P so that the temperature of the vacant region P is not lowered. When the resistances of the linking patterns 52 which heat the vacant regions are set as same or slightly large to increase exothermic quantity, a fear that the temperature of the vacant regions P is lowered is little and the temperature difference of the wafer W in a face is preferably uniform. When the resistance exothermic bodies 5 which were prepared by a printing method and the like are planar, the resistances of the linking patterns can be enlarged by lessening the line width Ws of the small arc-shaped belts 52 being the linking patterns by 1 to 5% than the line width Wp of the arc-shaped belts 51, and the temperature of the wafer W in a face can be uniformed by raising the temperature of the small arc-shaped belts 52 being the linking pattern than the temperature of the arc-shaped belts 51.

Further, in the ceramic heater 1 in which one main side of the plate-shaped ceramic body 2 with a plate thickness of 1 to 7 mm is set as the wafer heating face 3 mounting a wafer and the resistance exothermic bodies 5 were provided under the plane of the plate-shaped ceramic body 2, it is preferable that the thickness of the resistance exothermic bodies 5 is 5 to 50 μm and the area ratio of the resistance exothermic bodies 5 occupying the above-mentioned outer contact circle C is 5 to 30% for the area of the outer contact circle C surrounding in the above-mentioned resistance exothermic bodies 5, being viewed with a projection plane parallel to the main plane of the above-mentioned plate-shaped ceramic body 2.

Namely, when the area ratio of the resistance exothermic bodies 5 occupying in the outer contact circle C is less than 5% for the area of the outer contact circle C surrounding the resistance exothermic bodies 5, L1, L2 - - - and the like, which are the facing intervals of the facing regions in the facing regions facing the resistance exothermic bodies 5, too large; therefore the surface temperature of the wafer heating face 3 corresponding to the interval L1 where the resistance exothermic bodies 5 do not exist becomes little in comparison with other portions, and the temperature of the wafer heating face 3 is hardly uniformed. To the contrary, when the area ratio of the resistance exothermic bodies 5 occupying the above-mentioned outer contact circle C exceeds 30% for the area of the outer contact circle C surrounding the above-mentioned resistance exothermic bodies 5, thermal stress acting between both is too large even if the difference of the thermal expansion coefficients between the plate-shaped ceramic body 2 and the resistance exothermic bodies 5 is approximated to 2.0×10⁻⁶/° C. or less; therefore although the plate-shaped ceramic body 2 comprises a ceramic sintered body which is hardly deformed, there is a fear that the warp of the plate-shaped ceramic body 2 is generated so that the wafer heating face 3 side is a concave when the resistance exothermic bodies 5 are exothermically heated, because the thickness t of the plate is thin at 1 mm to 7 mm. As a result, the temperature at the central portion of the wafer W is smaller than its periphery and the unevenness of temperature is enlarged.

Further, preferably, the area ratio of the resistance exothermic bodies 5 occupying in the outer contact circle C is 7 to 20% and further preferably 8% to 15% for the area of the outer contact circle C surrounding the resistance exothermic bodies 5.

More specifically, it is preferable that the resistance exothermic bodies 5 have the facing regions in the facing regions facing the outer peripheral portion, and the interval L1 of the above-mentioned facing region is 0.5 mm or more and 3-fold or less of the plate thickness of the above-mentioned plate-shaped ceramic body 2. When the interval L1 of the above-mentioned facing region is 0.5 mm or less, there is a fear that whisker-like protrusions are generated at the facing region of the resistance exothermic bodies 5 at printing and forming the resistance exothermic bodies 5 and the portions are shorted. Further, when the interval L1 of the above-mentioned facing region exceeds 3-fold of the plate thickness of the plate-shaped ceramic body 2, there is fear that cool zones are generated on the surface of the wafer W corresponding to the facing region L1 and the temperature difference of the wafer W in a face is enlarged.

Further, the thickness of the resistance exothermic bodies 5 is preferably 5 to 50 μm for effectively expressing such effect.

When the thickness of the resistance exothermic bodies 5 is less than 5 μm, it is difficult to uniformly print the thickness of the resistance exothermic bodies 5 by a screen printing method, and when the thickness of the resistance exothermic bodies 5 exceeds 50 μm, there is a fear that even if the area ratio which the resistance exothermic bodies 5 occupy is 30% or less, the thickness of the resistance exothermic bodies 5 is large, the rigidity of the resistance exothermic bodies 5 is large and the plate-shaped ceramic body 2 is deformed by the influence of elongation and shrinkage of the resistance exothermic bodies 5 caused by the temperature change of the plate-shaped ceramic body 2. Further, it is difficult to print them in a uniform thickness by a screen printing and there is a fear that the temperature difference of the surface of the wafer W is enlarged. Further, the thickness of the resistance exothermic bodies 5 is preferably 10 to 30 μm.

Further, detailed compositions are illustrated.

FIG. 1 is a section view showing one example of the ceramic heater according to the present invention and one main side of the plate-shaped ceramic body 2 with a plate thickness of 1 to 7 mm and a Young's modulus of 200 to 450 MPa at 100 to 200° C. is set as the wafer heating face 3 on which the wafer W is mounted, the resistance exothermic body 5 is formed on another main side and the resistance exothermic body 5 is provided with the electric power supply portions 6 which are electrically connected with the resistance exothermic body 5.

As the material of the plate-shaped ceramic body 2 with a plate thickness of 1 to 7 mm and a Young's modulus of 200 to 450 MPa at 100 to 200° C., alumina, silicon nitride, SIALON and aluminum nitride can be used and among these, in particular, since aluminum nitride has a high thermal conductivity of 50 W/(m·K) or more and 100 W/(m·K) or more and is superior in corrosion resistance and plasma resistance for corrosive gas such as fluorine-base or chlorine-base; therefore it is preferably suitable for the material of the plate-shaped ceramic body 2.

The thickness of the plate-shaped ceramic body 2 is further preferably 2 to 5 mm. When the thickness of the plate-shaped ceramic body 2 is thinner than 2 mm, the strength of the plate-shaped ceramic body 2 is lost, it cannot endure thermal stress at heating by the exothermic of the resistance exothermic body 5 when cooling air is blown from the gas jetting orifices 24, and there is a fear that cracks are generated in the plate-shaped ceramic body 2. When the thickness of the plate-shaped ceramic body 2 exceeds 5 mm, the heat capacity of the plate-shaped ceramic body 2 is large; therefore there is a fear that a time until temperature at heating and cooling is stabilized is elongated.

The plate-shaped ceramic body 2 is elastically fixed by penetrating bolts 16 at the outer periphery of the opening portion of the metal case 19 having a bottom, letting a ring-shaped contact member 17 intervene so that the plate-shaped ceramic body 2 is not directly brought in contact with the metal case 19 having a bottom, letting the elastic body 18 intervene from the metal case 19 having a bottom and screwing the nuts 20. Thereby, even if the metal case 19 having a bottom is deformed when the temperature of the plate-shaped ceramic body 2 is fluctuated, it is absorbed by the above-mentioned elastic body 18; therefore the warp of the plate-shaped ceramic body 2 is suppressed and the generation of temperature unevenness caused by the warp of the plate-shaped ceramic body 2 on the wafer surface can be prevented.

As shown in FIGS. 9 and 10, the section of the ring-shaped contact member 17 may be polygonal or circular, but when the plate-shaped ceramic body 2 is brought in contact with the contact member 17 on a plane, the heat of the plate-shaped ceramic body 2 flowing into the metal case 19 having a bottom through the contact member 17 can be lessened when the width of the contact portion in contact with the plate-shaped ceramic body 2 and the contact member 17 is 0.1 mm to 13 mm. Further, the temperature difference of the wafer W in a face is small and the wafer W can be uniformly heated. It is further preferably 0.1 to 8 mm. When the width of the contact portion of the contact member 17 is 0.1 mm or less, there is a fear that the contact portion is deformed when it is brought in contact with the plate-shaped ceramic body 2 and the contact member is destroyed. Further, when the width of the contact portion of the contact member 17 exceeds 13 mm, the heat of the plate-shaped ceramic body 2 flows in the contact portion, the temperature of the peripheral portion of the plate-shaped ceramic body 2 is lowered and it becomes difficult to uniformly heat the wafer W. The width of the contact portion of the plate-shaped ceramic body 2 with the contact member 17 is preferably 0.1 mm to 8 mm and further preferably 0.1 to 2 mm.

Further, the thermal conductivity of the contact member 17 is preferably smaller than the thermal conductivity of the plate-shaped ceramic body 2. When the thermal conductivity of the contact member 17 is smaller than the thermal conductivity of the plate-shaped ceramic body 2, the distribution of temperature in the face of the wafer W mounted on the plate-shaped ceramic body 2 can be uniformly heated, and when the temperature of the plate-shaped ceramic body 2 is raised or lowered, the transmission quantity of heat with the contact member 17 is small, thermal interference with the metal case 19 having a bottom is little and temperature can be rapidly changed.

In the ceramic heater 1 in which the thermal conductivity of the contact member 17 is smaller than the thermal conductivity of the plate-shaped ceramic body 2 by 10% or less, the heat of the plate-shaped ceramic body 2 flows hardly in the metal case 19 having a bottom, heat flown by the heat transmission and radiant heat transmission by atmospheric gas (hereat, air) becomes much and to the contrary, the effect is little.

When the thermal conductivity of the contact member 17 is larger than the thermal conductivity of the plate-shaped ceramic body 2, the heat of the peripheral portion of the plate-shaped ceramic body 2 flows in the metal case 19 having a bottom through the contact member 17 and heats the metal case 19 having a bottom, the temperature of the peripheral portion of the plate-shaped ceramic body 2 is lowered and it is not preferable that the temperature difference of the wafer W in a face is enlarged. Further, since the metal case 19 having a bottom is heated, there has been a fear that a time for cooling is elongated because of the high temperature of the metal case 19 having a bottom even if the plate-shaped ceramic body 2 is cooled by jetting air from the gas jetting orifices 24 and a time for reaching at a fixed temperature is enlarged when it is heated to a fixed temperature.

On the other hand, as the material composing the contact member 17, the contact member with a Young's modulus of 1 GPa or more is preferable and 10 GPa or more is further preferable. The width of the contact portion is small at 0.1 mm to 8 mm by setting the Young's modulus. Even if the plate-shaped ceramic body 2 is fixed on the metal case 19 having a bottom with bolts through the contact member 17, the contact member 17 is not deformed, the position of the plate-shaped ceramic body 2 is not deviated, the degree of parallel is not changed and precision can be retained well.

Further, precision which cannot be obtained by a contact member described in the Reference 4 which comprises a fluorine-base resin and a resin in which glass fiber was added can be attained.

As the material of the contact member 17, metals such as carbon steel consisting of iron and carbon and specific steel in which nickel, manganese and chromium were added are preferable because the Young's modulus is large. Further, as a material having a small thermal conductivity, stainless steel and so-called covar such as Fe—Ni—Co-base alloy are preferable, and the material of the contact member 17 is preferably selected so as to be smaller than the thermal conductivity of the plate-shaped ceramic body 2.

Further, the contact portion of the contact member 17 with the plate-shaped ceramic body 2 is small and there is a fear that although the contact portion is small, the contact portion is damaged to generate particles, and the stable contact portion can be retained; therefore the section of the contact member 17 which was cut with a plane perpendicular to the plate-shaped ceramic body 2 is preferably circular than polygonal, and when a circular wire having a sectional diameter of 1 mm or less is used as the contact member 17, the surface temperature of the wafer W can be uniformed and rapidly raised and lowered without changing the positions of the plate-shaped ceramic body 2 and the metal case 19 having a bottom.

Then, the metal case 19 having a bottom has a side wall portion 22 and a bottom face 21 and the plate-shaped ceramic body 2 is provided so as to cover the opening portion of the metal case 19 having a bottom. Further, holes 23 for discharging cooling gas are provided on the metal case 19 having a bottom, and equipped with electric power supplying terminals 11 for conducting to the electric power supplying portions 6 which supplies electric power to the resistance exothermic body 5 of the plate-shaped ceramic body 2, the gas injection orifices 24 for cooling the plate-shaped ceramic body 2, and a thermo couple 27 for measuring the temperature of the plate-shaped ceramic body 2.

Further, the depth of the metal case 19 having a bottom is 10 to 50 mm and the bottom face 21 is preferably provided at a distance of 10 to 50 mm from the plate-shaped ceramic body 2. It is further preferably 20 to 30 mm. Because the thermal uniformity of the wafer heating face 3 is easy by the mutual radiation heat of the metal case 19 having a bottom and the plate-shaped ceramic body 2, and at the same time, since there is an adiabatic effect, and a time until the temperature of the wafer heating face 3 is constant and uniform temperature is shortened.

There is carried out a working of mounting the wafer W on the wafer heating face 3 and lifting up it from the wafer heating face 3 by lift pins 25 which were provided so as to be freely elevated in the metal case 19 having a bottom. The wafer W is retained in a condition in which it is floated by wafer supporting pins from the wafer heating face 3 and the unevenness of temperature caused by one-sided hit and the like is designed to be prevented.

Further, in order to heat the wafer W by the ceramic heater 1, after the wafer W which was carried to the upper side of the wafer heating face 3 by a convey arm (not illustrated) was supported by the lift pins 25, the lift pins 25 is descended and the wafer W is mounted on the wafer heating face 3.

Then, when the ceramic heater 1 is used for forming a resist film, it does not generate gas by reacting with moisture in air when the main component of the plate-shaped ceramic body 2 is silicon carbide; therefore even if it is used for pasting the resist film on the wafer W, it does not badly influence the tissue of the resist film and fine wiring can be formed in high density. At this time, it is necessary that a sintering aid does not contain a nitride which possibly forms ammonia and amine by reaction with water

Further, the silicon carbide sintered body forming the plate-shaped ceramic body 2 is obtained by adding boron (B) and (C) as the sintering aid against silicon carbide as a main component, or adding a metal oxide such as alumina (Al₂O₃) and yttria (Y₂O₃) to be adequately mixed, processing it in a tabular shape, and then calcining it at 1900 to 2100° C. Silicon carbide may be well either of those in which α-type is main or those in which β-type is main.

On the other hand, when the silicon carbide sintered body is used as the plate-shaped ceramic body 2, glass or a resin can be used as the insulating layer between the resistance exothermic bodies 5 and the plate-shaped ceramic body 2 having semi-conductivity, and when glass is used, voltage endurance is lower than 1.5 kV and insulation is not kept when its thickness is less than 100 μm. To the contrary, when its thickness exceeds 400 μm, the difference of the thermal expansion coefficients of the silicon carbide sintered body and the aluminum nitride sintered body which form the plate-shaped ceramic body 2 is too large; therefore cracks are generated and it does not function as the insulating layer. Accordingly, when glass is used as the insulating layer, the thickness of the insulating layer is preferably formed at a range of 100 to 400 μm, and desirably a range of 200 μm to 350 μm.

Further, the main side which is the reverse side of the plate-shaped ceramic body 2 and the wafer heating face 3 is polished at a flatness of 20 μm or less and a plane roughness of 0.1 μm to 0.5 μm by the average roughness of central line (Ra), from the viewpoint of enhancing adhering property with the insulating layer 4 comprising glass and a resin.

Further, when the plate-shaped ceramic body 2 is formed by a sintered body in which aluminum nitride is a main component, a rare earth metal element oxide such as Y₂O₃ or Yb₂O₃ as the sintering aid and an alkali earth metal oxide such as CaO according to requirement are added against aluminum nitride being a main component, the mixture is adequately mixed and processed in a plate shape, and then the plate-shaped ceramic body 2 is obtained by calcining it at 1900 to 2100° C. in nitrogen atmosphere. In order to improve the adhering property of the resistance exothermic body 5 against the plate-shaped ceramic body 2, the insulating layer comprising glass is occasionally formed. However, adequate glass is added in the resistance exothermic body 5, and when adequate adhering strength is obtained, this can be abbreviated.

Further, the property of glass forming the insulating layer may be crystalline or amorphous, and it is preferable that those in which thermal resistant temperature is 200° C. or more and the thermal expansion coefficient at a range of 0° C. to 200° C. is −5 to 5×10⁻⁷/° C. against the thermal expansion coefficient of ceramics composing the plate-shaped ceramic body 2 are suitably selected to be used. Namely, when glass having the thermal expansion coefficient out of the fore-mentioned range is used, the difference of the thermal expansion coefficient to that of ceramics forming the plate-shaped ceramic body 2 becomes to large; therefore defects such as crack and peeling at cooling after baking the glass are easily generated.

Further, as the procedure of pasting the insulating layer comprising glass on the plate-shaped ceramic body 2, an appropriate amount of the glass paste is dropped on the central portion of the plate-shaped ceramic body 2 and spread by a spin coat method to be uniformly coated, or it is uniformly coated by a screen printing method, a dipping method, a spray coating method and the like and then, the glass paste is baked at a temperature of 600° C. or more. Further, when glass is used as the insulating layer, the plate-shaped ceramic body 2 comprising the silicon carbide sintered body or the aluminum nitride sintered body is preliminarily heated at a temperature of 850 to 1300° C. and the surface on which the insulating layer is pasted is oxidation-treated; therefore the adhering property with the insulating layer comprising glass can be enhanced.

The pattern form of the resistance exothermic body 5 of the present invention is divided into a plural number of blocks shown in FIGS. 17 and 18, and respective blocks are tassel comprising an arc-shaped pattern and a straight line-shaped pattern and a zigzag folded form. Since it is important uniformly heat the wafer W in the ceramic heater 1 of the invention of the present application, these pattern forms are preferably that the density of the respective portions of the belt-shaped resistance exothermic bodies 5 is uniform. However, the surface temperature of the wafer W corresponding rough portions is little in the resistance exothermic body pattern in which the dense portion and the rough portion of the resistance exothermic bodies 75 appear alternately viewed from the center of the plate-shaped ceramic body 22 to a radiation direction as shown in FIG. 19, the temperature of the wafer W corresponding dense portions is large, and it is not preferable because the whole face of the surface of the wafer W cannot be uniformly heated.

Further, when the resistance exothermic bodies 5 are divided into a plural number of blocks, it is preferable that the wafer W on the wafer heating face 3 is uniformly heated by independently controlling the temperature of respective blocks.

The resistance exothermic bodies 5 are obtained by printing glass frit and an electrode paste containing a metal oxide on electroconductive metal particles by a printing method and baking them. As the metal particles, at least one metal among Au, Ag, Cu, Pd, Pt and Rh is preferably used. Further, as the glass frit, low expansion glass comprising an oxide containing B, Si and Zn whose thermal expansion coefficient is 4.5×10⁻⁶/° C. or less smaller than that of the plate-shaped ceramic body 2 is preferably used, and as the metal oxide, at least one kind selected from silicon oxide, boron oxide, alumina and titania is preferably used.

Hereat, at least one metal among Au, Ag, Cu, Pd, Pt and Rh is used as the metal particles forming the resistance exothermic bodies 5 because electric resistance is small.

As the glass frit forming the resistance exothermic bodies 5, since the thermal expansion coefficient of metal particles comprising an oxide containing B, Si and Zn which compose the resistance exothermic bodies 5 is larger than the thermal expansion coefficient of the plate-shaped ceramic body 2, the low expansion glass whose thermal expansion coefficient is 4.5×10⁻⁶/° C. or less smaller than that of the plate-shaped ceramic body 2 is preferably used in order to let the thermal expansion coefficient of the resistance exothermic bodies 5 be close to the thermal expansion coefficient of the plate-shaped ceramic body 2.

Further, the reason why as the metal oxide forming the resistance exothermic bodies 5, at least one kind selected from silicon oxide, boron oxide, alumina and titania is preferably used is that the adhering property with metal particles in the resistance exothermic bodies 5 is superior, further, its thermal expansion coefficient is close to the thermal expansion coefficient of the plate-shaped ceramic body 2 and the adhering property with the plate-shaped ceramic body 2 is superior.

However, when the content of the metal oxide exceeds 80% against the resistance exothermic bodies 5, it is not preferable that the resistance value of the resistance exothermic bodies 5 is large although the adhering property of the resistance exothermic bodies 5 increases. Consequently, the content of the metal oxide is preferably 60% or less.

As the resistance exothermic bodies 5 comprising electroconductive metal particles, glass frit and metal oxides, those in which the difference of the thermal expansion coefficient to that of the plate-shaped ceramic body 2 is 3.0×10⁻⁶/° C. or less are preferably used.

Namely, it is difficult in production the difference between the thermal expansion coefficient of the resistance exothermic bodies 5 and that of the plate-shaped ceramic body 2 is 0.1×10⁻⁶/° C. To the contrary, when the difference of the thermal expansion coefficient between the resistance exothermic bodies 5 and the plate-shaped ceramic body 2 exceeds 3.0×10⁻⁶/° C., there is a fear that when the resistance exothermic bodies 5 are heated, the wafer heating face 3 side is warped in a concave shape by thermal stress acting between the plate-shaped ceramic body 2.

Further, as the material of the resistance exothermic bodies 5 which is pasted on the insulating layer, a metal single body such as gold (Au), silver (Ag), Copper (Cu) or palladium (Pd) is directly pasted by a deposition method and a plating method, or a paste in which the metal single body, electroconductive metal oxides such as rhenium oxide (Re₂O₃) and lanthanum manganate (LaMnO₃) and the above-mentioned metal material are dispersed in a resin paste and a glass paste is prepared, printed in a fixed pattern form by a screen printing method and the like and baked, and then the electroconductive material is combined with a matrix comprising a resin and glass. When glass is used as the matrix, it may be either of crystallized glass and amorphous glass, but the crystallized glass is preferably used for suppressing the change of resistance value by heat cycle.

However, when silver (Ag) and Copper (Cu) are used as the material of the resistance exothermic bodies 5, there is a fear that migration is generated; therefore in such case, a coating layer comprising the same material as the insulating layer may be coated at a thickness of about 40 to 400 μm, so as to cover the resistance exothermic bodies 5

Further, with respect to the method of supplying electric power to the resistance exothermic bodies 5, connection is secured by pressuring the electric power supply terminals 11 which were provided on the metal case 19 having a bottom on the electric power supply portions 6 which were formed on the plate-shaped ceramic body 2, with springs (not illustrated), and electric power is supplied. It is because thermal uniformity is deteriorated by the heat volume of the terminal portions 11 when the terminal portions comprising a metal are buried in the plate-shaped ceramic body 2 with a thickness of 2 to 5 mm to be formed. Accordingly, as the present invention, thermal stress caused by the difference of temperature between the plate-shaped ceramic body 2 and the metal case 19 having a bottom is mitigated by pressuring the electric power supply terminals 11 with springs to secure electric connection, and electric conduction can be kept with high reliability. Further, an elastic conductor may be inserted as an intermediary layer in order to prevent that the contact point becomes a point contact. The intermediary layer has the effect only by inserting a foil-shaped sheet. Further, the diameter of the electric power supply terminals 11 at the electric power supply portions 6 is preferably 1.5 to 5 mm.

Further, the temperature of the plate-shaped ceramic body 2 is measured with the thermo couple 27 whose edge was buried in the plate-shaped ceramic body 2. As the thermo couple 27, the sheath type thermo couple 27 with an outer diameter of 0.8 mm or less is preferably used from the viewpoint of response property and the workability of retention. It is preferable that a hole is formed in the plate-shaped ceramic body 2 and the edge portion of the thermo couple 27 is pressured and fixed in the inner wall face of the hole by a fixing member which was provided therein for improving reliability. Similarly, it is also possible to measure temperature by burying a naked thermo couple and a temperature measuring resistor such as Pt.

Further, as shown in FIG. 1, a plural number of supporting pins 8 are provided on one main side 3 of the plate-shaped ceramic body 2 and the wafer W may be retained at a fixed distance from one main side of the plate-shaped ceramic body 2.

Further, in FIG. 1, the ceramic heater 1 which provided only the resistance exothermic bodies 5 on another main side 3 of the plate-shaped ceramic body 2 was shown, but it is needless to say that the present invention may be those in which an electrode for electrostatic absorption and plasma generation was buried between the main side 3 and the resistance exothermic bodies 5.

Further, in the above-mentioned ceramic heater, the above-mentioned ceramic heater can be used as a wafer heating device by setting one main side of the plate-shaped ceramic body 2 as a wafer heating face on which a wafer is mounted.

### EXAMPLE 1

Hereat, the ceramic heater of the present invention and a conventional ceramic heater are prepared, and there was carried out an experiment by which the resistance change rate of the resistance exothermic bodies being a conductor after heat cycle test and the presence or absence of cracks of the resistance exothermic bodies and the difference of temperature of wafer face were studied.

In the experiment, as the plate-shaped ceramic body composing a heater portion, a plate-shaped aluminum nitride sintered body having a thermal conductivity of about 120 W/(m·K) was used, which was obtained by adding powder of 5% by weight of Y₂O₃ to AlN powder, further adding appropriate amounts of a binder and a solvent and kneading and drying the mixture to prepare granulated powder, and filling the granulated powder in a mold and calcining it using a hot press process by which calcinations is carried out at a temperature of 1800 to 1900° C., while pressuring it at a mold pressure of 100 MPa. Then, after roughly polishing the main side forming the resistance exothermic bodies with a diamond grindstone of about #250, a finishing polish processing was carried out with a diamond grindstone of #400 or more, a plural number of disc-shaped the plate-shaped ceramic bodies 2 with a thickness of 3.0 mm and a diameter of 315 mm to 345 mm were prepared, and further, three penetration holes were equally formed on a concentric circle of 600 mm from the center. After the diameter of the penetration holes was set at 4 mm, it was coated by an oxide film with a thickness of 0.5 μm comprising alumina on its surface by heat treatment at conditions of 1000° C. and 3 hours.

Then, in the ceramic heater of the present invention, a glass paste was printed on one main side of the heating plate and baking treatment was carried out at 900° C. to prepare a glass layer. Further, the glass layer with a thermal expansion coefficient of glass of 4.8×10⁻⁶/° C. was used.

When a resistance exothermic body composing the ceramic heater was formed, a metal powder of Au (30% by weight) and Pt (10% by weight) and a resistance exothermic body paste which contains 60% by weight of glass including the crystals of Zn₂SiO₄, Zn₃B₂O₆, Zn₃(BO₃)₂, Zn(BO₂)₂ and SiO₂ (quartz) were used, and when the ceramic heater of the present invention was formed, the above-mentioned resistance exothermic body paste was printed on the glass layer, it was formed by calcination at a temperature of 600 to 700° C. When a conventional ceramic heater was formed, the above-mentioned resistance exothermic body paste was directly printed on a heating plate and it was prepared by calcination at a temperature of 600 to 700° C.

Further, the glass mixed were equally divided into two portions and granulated, and several kinds having different particle size distributions were prepared to be used by mixing at an equal amount.

Then, in order to paste the resistance exothermic body on the plate-shaped ceramic body, an electroconductive paste which was prepared by kneading an Au powder, a Pd powder and a glass paste as electroconductive material to which a binder was added was printed in a fixed pattern by a screen printing method and then heated at 150° C. to dry an organic solvent, it was treated with the removal processing of fat at 550° C. for 30 minutes and calcination at a temperature of 700 to 900° C. was carried out to form a resistance exothermic body with a thickness of 50 μm. The pattern arrangement of the resistance exothermic body was 7 pattern compositions in total in which a circle was divided in circular ring-shapes to a radial direction from a central portion, a pattern was circularly formed at the central portion, two patterns were formed at the circular ring-shaped portion at its outside and four patterns were formed at its further outside. Further, the diameter of the outer contact circle C of the outermost periphery of 4 patterns was 310 mm. Then, the plate-shaped ceramic body was prepared by soldering the electric power supply portions on the resistance exothermic bodies to be fixed.

Further, the metal case having a bottom was prepared with a Fe—Cr—Ni-base alloy, and prepared as a metal plate with a thickness of its bottom face of 2.0 mm and a metal plate composing its side wall portion a thickness of 1.0 mm. Further, gas jetting orifices, a thermocouple and conduction terminals were installed at fixed positions on the bottom face. A distance from the bottom face to the plate-shaped ceramic body was 20 mm.

Then, the plate-shaped ceramic body was overlapped on the opening portion of the case having a bottom, bolts were penetrated at its outer peripheral portion, a ring-shaped contact member was let intervene so that the plate-shaped ceramic body and the case having a bottom were not brought in contact, an elastic body was let intervene from the contact member side and nuts were screwed to prepare a ceramic heater.

Then, electric power was supplied to the resistance exothermic bodies of respective ceramic heaters obtained, heat cycle tests by which the temperature of a wafer mounted on the heating face was raised to 300° C. for 60 seconds and cooled to 40° C. or less for 240 seconds by forcible air cooling were carried out at 10000 cycles unit, and the resistance change of the resistance exothermic bodies before and after the heat cycle tests was confirmed. Further, the temperature of the wafer was measured using a resistance temperature measuring element provided in the wafer.

Then, the measurement was carried out using the wafer for measuring temperature with a diameter of 300 mm in which the resistance temperature measuring elements were buried at 29 spots. Electric powers were installed to the respective ceramic heaters, the temperature of the wafer W was raised from 25° C. to 200° C. for 5 minutes, the wafer W was heated so that after setting the temperature of the wafer W at 200° C., the average temperature of the wafer W was constant at a range of 200° C.±0.5° C., then the temperature was retained for 10 minutes, and the maximum temperature difference in the face of the wafer at that time was set at the temperature difference of the wafer at a normal time. Further, the wafer W was lifted up with lift pins while heating the ceramic heater and cooled to a room temperature of 25° C., then the wafer W was mounted on the wafer heating face, the temperatures of the respective portions of the wafer W until the average temperature of the wafer W was 200° C. were measured, and the difference between the maximum temperature and the minimum temperature in the face of the wafer W against a time axis was determined to be referred to as the difference of the maximum temperature in the face of the wafer at a transient time.

Further, the temperature of the wafer heating instrument prepared was raised to 300° C. for 2 minutes and retained for one minute, then heat cycle for forcibly cooling by air for 4 minutes was repeated, 10000 cycles of the temperature distribution of the wafer were carried out and the difference of the maximum temperature in the face was evaluated similarly as the above description.

The results are as shown in Table 1.

TABLE 1

| | | | | | | Mean | | | Maximum |
|---|---|---|---|---|---|---|---|---|---|
| | | | | | Mean particle | particle | | Temperature | temperature |
| | | | Thickness | | diameter of | diameter of | | difference | difference |
| | | Material | of | Presence of | lumps of | electro- | Number | of wafer at | of wafer at |
| | | of plateshaped | insulating | lumps of | insulating | conductive | of heat | stationary | transient |
| | Sample | ceramic | layer | insulating | composition | particles | cycle | time | time |
| | No. | body | (μm) | composition | (μm) | (μm) | (cycles) | (° C.) | (° C.) |
| * | 101 | AlN | 20 | No | — | 0.08 | 10000 | 3.56 | 14.8 |
| | 102 | AlN | 20 | Yes | 3 | 0.08 | 20000 | 0.84 | 6.4 |
| | 103 | AlN | 25 | Yes | 5 | 0.06 | 20000 | 0.78 | 6.5 |
| | 104 | AlN | 26 | Yes | 10 | 0.08 | 20000 | 0.71 | 8.4 |
| | 105 | AlN | 27 | Yes | 10 | 0.1 | 20000 | 0.53 | 5.6 |
| | 106 | SiC | 26 | Yes | 10 | 1 | 20000 | 0.52 | 5.5 |
| | 107 | SiC | 45 | Yes | 30 | 4 | 20000 | 0.55 | 5.7 |
| | 108 | AlN | 60 | Yes | 50 | 5 | 20000 | 0.57 | 5.8 |
| | 109 | AlN | 120 | Yes | 100 | 10 | 20000 | 0.82 | 7.3 |
| | 110 | AlN | 200 | Yes | 180 | 13 | 20000 | 0.88 | 7.6 |

Mark * shows “out of the present invention”.

As grasped from Table 1, in the sample No. 101, a conventional wafer heating device having no lumps of the insulating composition could not be used for a wafer heating device which repeats the rapid raising and cooling of temperature, because the temperature difference of a wafer at a stationary time after the heat cycle test of 0.1 billion cycles was large at 3.56° C. and the temperature difference in the face of a wafer at a transient time was also large at 14.8° C.

On the other hand, the samples No. 102 to No. 110 have the lumps of the insulating composition in the resistance exothermic bodies, and it was cleared that they show preferable properties that the temperature difference of a wafer at a stationary time was little at 1° C. or less even if the heat cycle test was repeated at 20000 cycles and further, the maximum temperature difference in the face of a wafer at a transient time was little at 8.4° C. or less.

Further, with respect to the samples No. 105 to No. 108 in which the mean particle diameter of lumps of the insulating composition was 3 to 100 μm and the mean particle diameter of electroconductive particles was 0.1 to 5 μm, it was cleared that it was further preferable that the temperature difference of a wafer at a stationary time was 0.57° C. or less and the maximum temperature difference in the face of a wafer at a transient time was little at 5.8° C. or less. It is considered that the cause is that the durability of the resistance exothermic bodies was increased by the synergetic effect between the mean particle diameter of electroconductive particles and the mean particle diameter of the insulating composition.

### EXAMPLE 2

The plate-shaped ceramic bodies were prepared in the same manner as Example 1. Various metals, a glass component and a metal oxide were mixed as a paste which was the resistance exothermic bodies, and after it was prepared as paste-shape, it was screen-printed to prepare wafer heating devices.

A wafer was mounted on the wafer heating devices prepared, electric power was applied to the resistance exothermic bodies and evaluation was carried out in the same manner as Example 1. The results are shown in Table 2.

TABLE 2

| | | | Mean | Mean | | | | | | | Maximum |
|---|---|---|---|---|---|---|---|---|---|---|---|
| | Thick- | | particle | particle | | | Area ratio | | | Temperature | temperature |
| | ness | | diameter of | diameter | Presence of | Number of | of particles | | Change | difference of | difference of |
| | of in- | Presence of | lumps of | of electro- | particles in | particles in | in lumps of | Number | rate of | wafer at | wafer at |
| Sam- | sulating | lumps of | insulating | conductive | lumps of | lumps of | insulating | of heat | resistance | stationary | transient |
| ple | layer | insulating | composition | particles | insulating | insulating | composition | cycle | after heat | time | time |
| No. | (μm) | composition | (μm) | (μm) | composition | composition | (%) | (cycles) | cycle (%) | (° C.) | (° C.) |
| 121 | 20 | Yes | 5 | 1.5 | No | 0 | 0 | 20000 | 1.63 | 0.77 | 6.4 |
| 122 | 21 | Yes | 5 | 1.5 | Yes | 1 | 9 | 40000 | 0.53 | 0.46 | 4.7 |
| 123 | 23 | Yes | 9 | 1.5 | Yes | 3 | 2.8 | 40000 | 0.52 | 0.43 | 4.6 |
| 124 | 40 | Yes | 15 | 1.5 | Yes | 7 | 7 | 40000 | 0.51 | 0.42 | 4.6 |
| 125 | 46 | Yes | 20 | 1.5 | Yes | 13 | 7.3 | 40000 | 0.49 | 0.41 | 4.7 |
| 126 | 80 | Yes | 40 | 1.5 | Yes | 34 | 4.8 | 40000 | 0.53 | 0.43 | 4.7 |
| 127 | 80 | Yes | 43 | 1.5 | Yes | 41 | 5.0 | 40000 | 0.63 | 0.48 | 4.6 |
| 128 | 100 | Yes | 85 | 2.1 | Yes | 50 | 3.1 | 40000 | 0.82 | 0.49 | 4.7 |
| 129 | 120 | Yes | 100 | 2.5 | Yes | 195 | 12.2 | 40000 | 1.21 | 0.61 | 5.9 |

With respect to the sample No. 121, since particles do not exist in the insulating composition, the change rate of resistance after heat cycle of 20000 cycles was slightly large at 1.63% and the temperature difference of a wafer at a stationary time was slightly large at 0.77° C. Further, the maximum temperature difference in the face of a wafer at a transient time was slightly large at 6.4° C. This is deduced because the resistance exothermic bodies moved by heat cycle and phenomena such as peeling were generated at minute portions.

To the contrary, with respect to the samples No. 122 to No. 129 in which electroconductive particles exist in the insulating composition, it was grasped that it was superior that the change rate of resistance after repetition of the heat cycle of 40000 cycles was little at 1.21% or less and the temperature difference of a wafer at a stationary time was little at 0.61° C. or less.

Further, with respect to the samples No. 122 to No. 128 in which electroconductive particles exist in the insulating composition and the area ratio was 10% or less, it was grasped that it showed further superior property that the temperature difference of a wafer at a stationary time was little at 0.49° C. or less and the temperature difference in the face of a wafer at a transient time was little at 4.7° C. or less.

### EXAMPLE 3

Hereat, the ceramic heater of the present invention and a conventional ceramic heater were prepared, and there was carried out an experiment by which the resistance change rate of the resistance exothermic bodies after heat cycle test and the presence or absence of cracks of an oxide film were studied.

In the experiment, as the plate-shaped ceramic body composing a heater portion, a plate-shaped aluminum nitride sintered body having a thermal conductivity of about 120 W/(m·K) was used, which was obtained by adding powder of 5% by weight of Y₂O₃ to AlN powder, further adding appropriate amounts of a binder and a solvent and kneading and drying the mixture to prepare granulated powder, and filling the granulated powder in a mold and calcining it using a hot press process by which calcinations is carried out at a temperature of 1800 to 1900° C., while pressuring it at a mold pressure of 100 MPa. Then, after roughly polishing the main side forming the resistance exothermic bodies with a diamond grindstone of about #250, a finishing polish processing was carried out with a diamond grindstone of #400 or more, a plural number of the disc-shaped and plate-shaped ceramic bodies 2 with a thickness of 3.0 mm and a diameter of 315 mm to 345 mm were prepared, and further, three penetration holes were equally formed on a concentric circle of 600 mm from the center. After the diameter of the penetration holes was set at 4 mm, it was prepared by coating an oxide film with a thickness of 0.5 μm comprising alumina on its surface by heat treatment at conditions of 1000° C. and 3 hours. Further, finishing polishing treatment was carried out with a diamond grindstone of about #400 or more, the surface was treated with lapping, the fine unevenness of the surface was covered with a foaming agent comprising Si₃N₄, and the insulating layer and the resistance exothermic bodies were formed to be able to prepare pores on the insulating layer and the resistance exothermic bodies along the interface. Further, the grinding particles of the lapping contained alumina as a main component and 0.001 to 0.1% by mass or less of fine powders such as Si₃N₄ and AlN, and the size and number of the pores were adjusted.

Then, in the ceramic heater of the present invention, a glass paste was printed on one main side of the heating plate and baking treatment was carried out at 900° C. to prepare a glass layer. Further, the glass layer with a thermal expansion coefficient of glass of 4.8×10⁻⁶/° C. was used.

When a resistance exothermic body composing the ceramic heater was formed, a metal powder of Au (30% by weight) and Pt (10% by weight) and a resistance exothermic body paste which contains 60% by weight of glass including the crystals of Zn₂SiO₄, Zn₃B₂O₆, Zn₃(BO₃)₂, Zn(BO₂)₂ and SiO₂ (quartz) were used, and when the ceramic heater of the present invention was formed, the above-mentioned resistance exothermic body paste was printed on the glass layer, it was formed by calcination at a temperature of 600 to 700° C. When a conventional ceramic heater was formed, the above-mentioned resistance exothermic body paste was directly printed on a heating plate and it was prepared by calcination at a temperature of 600 to 700° C.

Then, in order to paste the resistance exothermic bodies on the plate-shaped ceramic body, an electroconductive paste which was prepared by kneading an Au powder, a Pd powder and a glass paste to which a binder was added was printed in a fixed pattern by a screen printing method and then heated at 150° C. to dry an organic solvent, it was treated with the removal processing of fat at 550° C. for 30 minutes and calcination at a temperature of 700 to 900° C. was carried out to form a resistance exothermic body with a thickness of 50 μm. The pattern arrangement of the resistance exothermic body was 7 pattern compositions in total in which a circle was divided in circular ring-shapes to a radial direction from a central portion, a pattern was circularly formed at the central portion, two patterns were formed at the circular ring-shaped portion at its outside and four patterns were formed at its further outside. Further, the diameter of the outer contact circle C of the outermost periphery of 4 patterns was 310 mm. Then, the plate-shaped ceramic body was prepared by soldering the electric power supply portions on the resistance exothermic bodies to be fixed.

Further, the metal case having a bottom was prepared with a Fe—Cr—Ni-base alloy, and prepared as a metal plate with a thickness of its bottom face of 2.0 mm and a metal plate composing its side wall portion a thickness of 1.0 mm. Further, gas jetting orifices, a thermocouple and conduction terminals were installed at fixed positions on the bottom face. A distance from the bottom face to the plate-shaped ceramic body was 20 mm.

Then, the plate-shaped ceramic body was overlapped on the opening portion of the case having a bottom. Bolts were penetrated at the outer peripheral portion, a ring-shaped contact member was let intervene so that the plate-shaped ceramic body and the case having a bottom were not brought in contact, an elastic body was let intervene from the contact member side and nuts were screwed to prepare a ceramic heater.

Then, electric power was supplied to the resistance exothermic bodies of respective ceramic heaters obtained, heat cycle tests by which the temperature of a wafer mounted on the heating face was raised to 300° C. for 60 seconds and cooled to 40° C. or less for 300 seconds by forcible air cooling were carried out at 10000 cycles unit, and the resistance change of the resistance exothermic bodies before and after the heat cycle tests was confirmed. Further, the temperature of the wafer was measured using a resistance temperature measuring element provided in the wafer.

Then, the measurement was carried out using the wafer for measuring temperature with a diameter of 300 mm in which the resistance temperature measuring elements were buried at 29 spots. Electric power sources were installed to the respective ceramic heaters, the temperature of the wafer W was raised from 25° C. to 200° C. for 5 minutes, the wafer W was heated so that after setting the temperature of the wafer W at 200° C., the average temperature of the wafer W was constant at a range of 200° C.±0.5° C., then the temperature was retained for 10 minutes, and the maximum temperature difference in the face of the wafer at that time was set at the temperature difference of the wafer at a stationary time. Further, the wafer W was lifted up with lift pins while heating the ceramic heater and cooled to a room temperature of 25° C., then the wafer W was mounted on the wafer heating face, the temperatures of the respective portions of the wafer W until the average temperature of the wafer W was 200° C. were measured, and the difference between the maximum temperature and the minimum temperature in the face of the wafer W against a time axis was determined to be referred to as the difference of the maximum temperature in the face of the wafer at a transient time.

Further, the portion of the plate-shaped ceramic body after the above-mentioned evaluation was cut out, the presence or absence of cracks in the insulating layer and the resistance exothermic bodies was confirmed and the size and distribution of sectional pores were measured.

Further, with respect to the line density, respective three photos of SEM photographs of the section of the joint interface between the plate-shaped ceramic body and the resistance exothermic bodies are photographed at a magnification of 200, 500, 1000, 5000 and 10000, and the number of the pores of 0.5 mm or more on respective photos at a belt-shaped region with a length of 10 cm along the joint interfaces on the respective photos was divided by the real dimension equivalent to 10 cm to obtain numbers. The largest value among the numbers was referred to as the line density.

The results are as shown in Table 3.

TABLE 3

| | | | | | | | Presence of | Change rate | | Maximum |
|---|---|---|---|---|---|---|---|---|---|---|
| | | | | | | | cracks in | of resistance | Temperature | temperature |
| | Material of | Thickness | | | | | insulating layer | value of | difference of | difference in |
| | plateshaped | of | | | Mean value | Line density | or resistance | resistance | wafer at | face of wafer |
| Sample | ceramic | insulating | Presence | Size of | of size of | of pores | exothermic | exothermic | stationary | at transient |
| No. | body | layer (μm) | of pores | pores (μm) | pores (μm) | (number/m) | bodies | bodies | time (° C.) | time (° C.) |
| 201 | AlN | 50 | No | 0.01 to 0.09 | 0.05 | 12820000 | Yes | 1.5 | 1.36 | 10.5 |
| 202 | AlN | 0 | Yes | 0.05 to 0.2 | 0.1 | 5720000 | No | 0.3 | 0.48 | 6.4 |
| 203 | AlN | 150 | Yes | 0.32 to 0.8 | 0.5 | 1230000 | No | 0.3 | 0.47 | 6.5 |
| 204 | AlN | 200 | Yes | 0.5 to 2.1 | 1 | 930000 | No | 0.3 | 0.29 | 6.3 |
| 205 | AlN | 200 | Yes | 1.5 to 4.1 | 3 | 500000 | No | 0.3 | 0.29 | 4.7 |
| 206 | SiC | 200 | Yes | 5.2 to 9.3 | 7 | 320000 | No | 0.25 | 0.27 | 4.6 |
| 207 | SiC | 200 | Yes | 8.3 to 13.2 | 10 | 80000 | No | 0.25 | 0.27 | 4.6 |
| 208 | SiC | 200 | Yes | 12.2 to 18.1 | 15 | 30000 | No | 0.25 | 0.27 | 4.7 |
| 209 | AlN | 200 | Yes | 15.3 to 24.8 | 20 | 10000 | No | 0.3 | 0.28 | 4.7 |
| 210 | AlN | 200 | Yes | 21.1 to 28.3 | 25 | 1000 | No | 0.3 | 0.28 | 4.7 |
| 211 | AlN | 200 | Yes | 25.3 to 38.9 | 30 | 800 | No | 0.3 | 0.28 | 6.5 |
| 212 | AlN | 200 | Yes | 32.6 to 47.7 | 40 | 500 | No | 0.3 | 0.48 | 6.6 |
| 213 | SiC | 200 | Yes | 43.5 to 56.4 | 50 | 400 | No | 0.5 | 0.49 | 6.7 |

As grasped from Table 3, in the sample No. 201, cracks were observed in the insulating layer after a heat cycle test in a conventional ceramic heater having no pores. Further, the change of resistance value of the resistance exothermic bodies was large before and after the heat cycle test.

To the contrary, as the sample No. 202, the ceramic heater of the present invention having pores had no cracks in the resistance exothermic bodies and showed preferable property.

Further, as the samples No. 203 to No. 213, the ceramic heaters equipped with the insulating layer and further equipped with pores had no cracks in the resistance exothermic bodies and showed superior property.

Further, as the samples No. 202 to No. 212, the change rate of resistance value of the resistance exothermic bodies was little at 0.3% or less in the ceramic heaters in which the size of pores was 0.05 to 50 μm, and they showed superior property.

Further, as the samples No. 204 to No. 211, when the mean value of the size of pores was 1 to 30 μm, the temperature difference of a wafer at a stationary time was little at 0.29° C. or less and they showed superior property.

Further, as the samples No. 205 to No. 210, when the line density of pores was 1000 to 500000/m, the maximum temperature difference in a face of a wafer at a transient time was little at 4.7° C. or less and they showed the most superior property.

### EXAMPLE 4

The plate-shaped ceramic bodies were prepared in the same manner as Example 3, various metals, a glass component and a metal oxide were mixed as the pastes which were the resistance exothermic bodies, and it was prepared in a paste-shape and screen-printed to prepare wafer heating devices.

A wafer was mounted on the wafer heating devices prepared, electric power was applied to the resistance exothermic bodies and evaluation was carried out in the same manner as Example 3. The results are shown in Table 4.

TABLE 4

| | | | Difference | |
|---|---|---|---|---|
| | | | of thermal | |
| | | | expansion | |
| | Name of | Main | coefficient to | Temperature |
| | electroconductive | component of | plate-shaped | difference of |
| Sam- | metal particles | aid (comprising | ceramic | wafer at |
| ple | and proportion | glass phase | body | stationary |
| No. | (% by mass) | or metal oxide) | (/° C.) | time (° C.) |
| 250 | Ag: 60 | Zn₂SiO₄ | 4.0 × 10⁻⁶ | 0.48 |
| 251 | Ag: 50 | SiO₂.B₂O₃.Al₂O₃ | 3 × 10⁻⁶ | 0.19 |
| 252 | Au: 50 | SiO₂.B₂O₄.ZnO | 2.5 × 10⁻⁶ | 0.18 |
| 253 | Cu: 30 | B₂O₃.ZnO | 2.1 × 10⁻⁶ | 0.17 |
| 254 | Pd: 28 | SiO₂.B₂O₃.Al₂O₃ | 3.0 × 10⁻⁶ | 0.19 |
| 255 | Pt: 30 | SiO₂.B₂O₄.ZnO | 0.1 × 10⁻⁶ | 0.14 |
| 256 | Rh: 50 | B₂O₃.ZnO | 0.1 × 10⁻⁶ | 0.14 |
| 257 | Au:Pt = 30:10 | SiO₂.B₂O₃.Al₂O₃ | 0.1 × 10⁻⁶ | 0.13 |
| 258 | Au:Pt = 20:10 | SiO₂.B₂O₄.ZnO | 1.51 × 10⁻⁶ | 0.18 |
| 259 | Ag: 65 | B₂O₃.ZnO | 3.5 × 10⁻⁶ | 0.47 |

With respect to the samples No. 251 to No. 258, since the difference between the thermal expansion coefficient of the resistance exothermic bodies sintered and the thermal expansion coefficient of the plate-shaped ceramic body was little at 3×10⁻⁶/° C. or less and it was grasped that the temperature difference of a wafer at a stationary time was preferably little at 0.19° C. or less.

However, with respect to the samples No. 250 and No. 259, the thermal expansion coefficient of the resistance exothermic bodies exceeds 3×10⁻⁶/° C. which was large, and the temperature differences of a wafer at a stationary time were also large at 0.48° C. and 0.47° C.

With respect to the samples No. 255 to No. 257, the difference between the thermal expansion coefficient of the resistance exothermic bodies sintered and the thermal expansion coefficient of the plate-shaped ceramic body was little at 0.1×10⁻⁶/° C. or less, and it was grasped that the temperature difference of a wafer at a stationary time was further preferably little at 0.14° C. or less.

### EXAMPLE 5

Further, ceramic heaters were prepared in the same manner as Example 3. The thickness of the bottom face of a metal case having a bottom comprised aluminum of 2.0 mm and aluminum of 1.0 mm composing a side wall portion, and gas jetting orifices, a thermocouple and conduction terminals were installed at fixed positions on the bottom face. Further, a distance from the bottom face to the plate-shaped ceramic body was 20 mm.

Further, ceramic heaters were prepared with two structures of a supporting structure A which supports the under face of the peripheral portion of the plate-shaped ceramic body and a supporting structure B which supports the outer peripheral end face of the plate-shaped ceramic body. Further, the diameter of the plate-shaped ceramic body and the diameter of the outer form of the metal case were the same in the supporting structure A.

Further, the section of the contact member was circular and ring-shaped. The size of a circular section was a diameter of 1 mm. Further, SUS 304 and carbon steel were used for the material of the contact member. Various ceramic heaters prepared were referred to as the samples No. 261 to No. 273.

The evaluation of the ceramic heaters prepared was carried out using a wafer for measuring temperature with a diameter of 300 mm in which temperature measuring resistant bodies were buried at 29 spots. Electric power was applied to the resistance exothermic bodies of the respective ceramic heaters, and the heat cycle test of 10000 cycles was carried out, in which the temperature of the wafer W which was mounted on the heating face was raised to 300° C. for 60 seconds and cooled to 40° C. or less for 300 seconds. Then, the temperature of the wafer W was raised from 25° C. to 200° C. for 5 minutes, the wafer W was heated until the average temperature of the wafer W was constant at a range of 200° C.±0.5° C. after setting the temperature of the wafer W at 200° C., then the temperature was retained for 10 minutes, and the difference between the maximum value and the minimum value of temperature of the wafer at that time was measured as the temperature difference of the wafer W at a stationary time. Further, the wafer W was lifted up with lift pins while heating the ceramic heater and cooled to a room temperature of 25° C., then the wafer W was mounted on the wafer heating face, the temperatures of the respective portions of the wafer W until the average temperature of the wafer W was 200° C. were measured, and the difference between the maximum temperature and the minimum temperature in the face of the wafer W against a time axis was determined to be referred to as the difference of the maximum temperature in the face of the wafer at a transient time.

Respective results are as shown in Table 5.

TABLE 5

| | Ratio of | | | |
|---|---|---|---|---|
| | diameter of outer | | | |
| | contact circle | | | |
| | of the resistance | | | |
| | exothermic | | | Maximum |
| | bodies 5 | Supporting | Temperature | temperature |
| | to diameter of | structure of | difference of | difference in |
| | plate-shaped | plate-shaped | wafer at | face of wafer at |
| Sample | ceramic | ceramic | stationary | transient time |
| No. | body 2 (%) | body | time (° C.) | (° C.) |
| 261 | 85 | A | 0.54 | 8.97 |
| 262 | 90 | A | 0.42 | 6.52 |
| 263 | 92 | A | 0.24 | 4.50 |
| 264 | 93 | A | 0.24 | 4.23 |
| 265 | 95 | A | 0.24 | 4.23 |
| 266 | 95 | A | 0.23 | 4.21 |
| 267 | 95 | B | 0.23 | 4.19 |
| 268 | 96 | B | 0.23 | 4.21 |
| 269 | 97 | B | 0.24 | 4.22 |
| 270 | 98 | B | 0.24 | 4.24 |
| 271 | 98 | B | 0.24 | 4.25 |
| 272 | 99 | B | 0.46 | 5.85 |
| 273 | 99.5 | B | 0.52 | 8.73 |

A fixes the plate-shaped ceramic body on the metal case through the connecting member.
B fixes the outer peripheral face of the plate-shaped ceramic body on the metal case though the contact member.

With respect to the sample No. 261 in Table 5, the ratio of the outer contact circle of the resistance exothermic bodies to the diameter of the plate-shaped ceramic body was little at 85% and the temperature difference of the wafer at a stationary time was slightly large at 0.54° C.

Further, with respect to the sample No. 273, the ratio of the outer contact circle of the resistance exothermic bodies to the diameter of the plate-shaped ceramic body was large at 99.5%, the temperature difference of the wafer at a stationary time was slightly large at 0.52° C. and the maximum temperature difference in a face of the wafer at a transient time was also slightly large at 8.73° C.

To the contrary, since the samples No. 262 to No. 272 are superior in that the temperature difference of the wafer at a stationary time was little at 0.46° C. or less and further, the maximum temperature difference in a face of the wafer at a transient time was little at 6.52° C. or less, it was cleared that the ceramic heater, in which the ratio of the diameter of the outer contact circle of the resistance exothermic bodies to the diameter of the plate-shaped ceramic body was 90 to 99%, is a superior heater.

Further preferably, as shown in samples No. 263 to 271, it was cleared that the ceramic heater, in which when the ratio of the outer contact circle of the resistance exothermic bodies to the diameter of the plate-shaped ceramic body is 92 to 98%, the temperature difference of the wafer at a stationary time was little at 0.24° C. or less, is a superior heater.

### EXAMPLE 6

Plate-shaped ceramic heaters were prepared in the same manner as Example 3.

However, ceramic heaters were prepared setting that the thickness of the plate-shaped ceramic body was 0.5 to 10 mm and the thickness of the resistance exothermic bodies was 1 to 100 μm.

Further, evaluation was carried out in the same manner as Example 3. The results are as shown in Table 6.

TABLE 6

| | Thickness of | Thickness | Temperature | Maximum |
|---|---|---|---|---|
| | plate-shaped | of the | difference of | temperature |
| | ceramic | resistance | wafer at | difference in face of |
| Sample | body | exothermic | stationary | wafer at transient |
| No. | 2 (mm) | bodies (μm) | time (° C.) | time (° C.) |
| 285 | 0.5 | 30 | 0.54 | 11.50 |
| 286 | 1 | 30 | 0.30 | 4.21 |
| 287 | 2 | 30 | 0.21 | 4.19 |
| 288 | 3 | 1 | 0.20 | 6.51 |
| 289 | 3 | 5 | 0.20 | 4.17 |
| 290 | 3 | 10 | 0.20 | 4.17 |
| 291 | 3 | 30 | 0.21 | 4.16 |
| 292 | 3 | 50 | 0.21 | 4.16 |
| 293 | 3 | 70 | 0.22 | 4.17 |
| 294 | 3 | 100 | 0.22 | 6.52 |
| 295 | 5 | 30 | 0.22 | 4.18 |
| 296 | 7 | 30 | 0.30 | 4.19 |
| 297 | 10 | 30 | 0.48 | 7.29 |

As a result, as the sample No. 285, the temperature difference of the wafer at a stationary time was slightly large at 0.54° C. in a ceramic heater in which the thickness of the plate-shaped ceramic body was little at 0.5 mm. As the sample No. 297, the temperature difference of the wafer at a stationary time was slightly large at 0.48° C. in a ceramic heater in which the thickness of the plate-shaped ceramic body was large at 10 mm.

Further, as the sample No. 288, the maximum temperature difference in a face of the wafer at a transient time was also slightly large at 6.51° C. in a ceramic heater in which the thickness of the resistance exothermic bodies was little at 1 μm.

Further, as shown in the sample No. 294, the maximum temperature difference in a face of the wafer at a transient time was slightly large at 6.52° C. in a ceramic heater in a ceramic heater in which the thickness of the resistance exothermic bodies was thick at 100 μm.

To the contrary, as shown in the samples Nos. 286, 287, 289 to 293, 295 and 296, the temperature difference of the wafer at a stationary time was little at 0.30° C. or less and the temperature difference of the wafer at a time of raising temperature was little at 4.21° C. or less in a ceramic heater in which the thickness of the plate-shaped ceramic body was 1 to 7 mm and the thickness of the resistance exothermic bodies was 5 to 70 μm. Therefore, it was grasped that it was superior.

Further, as shown in the samples Nos. 287, 289 to 293 and 295, the temperature difference of the wafer at a stationary time was little at 0.22° C. or less and the maximum temperature difference in a face of the wafer at a transient time was also little at 4.19° C. or less in a ceramic heater in which the thickness of the plate-shaped ceramic body was 2 to 5 mm and the thickness of the resistance exothermic bodies was 5 to 70 μm. Therefore, it was grasped that it was superior.

### EXAMPLE 7

Firstly, 1.0% by weight of yttrium oxide converted to weight was added to aluminum nitride powder and further, the slurry of aluminum nitride was prepared with a ball mill using isopropyl alcohol and urethane balls by being kneaded for 48 hours.

Then, the slurry of aluminum nitride was passed through 200 meshes and dried with an explosion-proof dryer at 120° C. for 24 hours after removing the urethane balls and dusts on the ball mill.

Then, the slip of aluminum nitride was prepared by mixing an acryl-base binder and a solvent with the aluminum nitride powder obtained and a plural number of the green sheets of aluminum nitride by a doctor blade method were prepared.

Further, a plural number of the green sheets of aluminum nitride obtained were thermally laminated to form a laminate by clamping.

Then, after the fat of the laminate was removed at a temperature of 500° C. for 5 hours in non oxidative gas flow, it was calcined at a temperature of 1900° C. for 5 hours in non oxidative gas flow to prepare plate-shaped ceramic bodies having various thermal conductivities.

Further, the aluminum nitride sintered bodies were polished, a plural number of sheets of the disc-shaped ceramic bodies with a plate thickness of 3 mm and a diameter of 330 mm were prepared and further, three penetration holes were equally formed on a concentric circle at a distance of 60 mm from the center. The diameter of the penetration holes were 4 mm.

Then, in order to paste the resistance exothermic bodies on the plate-shaped ceramic body, an electroconductive paste which was prepared by kneading an Au powder, a Pd powder and a glass paste to which a binder comprising the fore-mentioned similar composition was added was printed in a fixed pattern by a screen printing method and then heated at 150° C. to dry an organic solvent, it was treated with the removal processing of fat at 550° C. for 30 minutes and calcination at a temperature of 700 to 900° C. was carried out to form resistance exothermic bodies with a thickness of 50 μm.

The pattern arrangement of the resistance exothermic body zones was the compositions of the 8 resistance exothermic body zones in total in which a resistance exothermic body zone was formed at one circle with 25% of the diameter D of the plate-shaped ceramic body at the central portion, a resistance exothermic body zone was formed at a circular ring at its outside, a circular ring whose outer diameter was 45% of D was divided into two resistance exothermic body zones at its outside, and further, a circular ring whose inner diameter of the resistance exothermic body zone was 70% of D at the outermost periphery was divided into four resistance exothermic body zones. Further, samples were prepared by setting the diameter of the outer contact circle C of the four resistance exothermic body zones at the outermost periphery as 310 mm. Then, the plate-shaped ceramic bodies 2 were prepared by soldering the electric power supply portions 6 on the resistance exothermic bodies 5 to be fixed. Further, in the present Example, the resistance exothermic body at the central portion and the circular ring-shaped exothermic bodies at its outside were simultaneously heated to be controlled.

Further, there was prepared a wafer heating device in which a distance L1 between arc-shaped belts was set as a distance L2 between arc-shaped patterns which are adjacent to a radius direction, its ratio was referred to as L1/L2×100% and the ratio was changed.

Further, the thickness of the bottom face of a metal case having a bottom comprised aluminum of 2.0 mm and aluminum of 1.0 mm composing a side wall portion, and gas jetting orifices, a thermocouple and conduction terminals were installed at fixed positions on the bottom face. Further, a distance from the bottom face to the plate-shaped ceramic body was 20 mm.

Then, the plate-shaped ceramic body was overlapped on the opening portion of the metal case having a bottom, bolts were penetrated at the outer peripheral portion, a ring-shaped contact member was let intervene so that the plate-shaped ceramic body and the case having a bottom were not directly brought in contact, an elastic body was let intervene from the contact member side and nuts were screwed to prepare a ceramic heater.

Further, the section of the contact member 17 is L-character shaped and ring-shaped and brought in circular ring-shaped contact with the L-character shaped upper face of step portion and the under face of the plate-shaped ceramic body, and the width of the contact face with the plate-shaped ceramic body was 3 mm. Further, a thermal resistant resin was used as the material of the contact member. The various ceramic heaters prepared were referred to as the samples No. 301 to No. 309.

The evaluation of the ceramic heaters prepared was carried out using the wafer for measuring temperature with a diameter of 300 mm in which the resistance temperature measuring elements were buried at 29 spots. Electric power sources were installed to the respective ceramic heaters, the temperature of the wafer W was raised from 25° C. to 200° C. for 5 minutes, the wafer W was removed after setting the temperature of the wafer W at 200° C., the wafer W for measuring temperature at room temperature was mounted on the wafer heating face, and measurement was carried out by setting a time until the average temperature of the wafer W was constant at a range of 200° C.±0.5° C. as a response time. Further, after the temperature cycle in which temperature was raised from 30° C. to 200° C. for 5 minutes and then the temperature was retained for 5 minutes and cooled for 30 minutes was repeated by 1000 cycles, it was set from room temperature to 200° C., and measurement was carried out setting the difference between the maximum value and the minimum value of the wafer temperature after 10 minutes, as the temperature difference of the wafer W

Respective results are as shown in Table 7.

TABLE 7

| | | Composition of | Number of | | |
|---|---|---|---|---|---|
| | | resistance | resistance | L1/L2 × | Temperature |
| | Sample | exothermic | exothermic | 100 | difference of |
| | No. | body zones | body zones | (%) | wafer (° C.) |
| * | 301 | Plural number of | 8 | 20 | 1.20 |
| | | circle, ring and | | | |
| | | fan shapes | | | |
| | 302 | Plural number of | 8 | 30 | 0.49 |
| | | circle, ring and | | | |
| | | fan shapes | | | |
| | 303 | Plural number of | 8 | 40 | 0.39 |
| | | circle, ring and | | | |
| | | fan shapes | | | |
| | 304 | Plural number of | 8 | 50 | 0.28 |
| | | circle, ring and | | | |
| | | fan shapes | | | |
| | 305 | Plural number of | 8 | 60 | 0.38 |
| | | circle, ring and | | | |
| | | fan shapes | | | |
| | 306 | Plural number of | 8 | 80 | 0.43 |
| | | circle, ring and | | | |
| | | fan shapes | | | |
| | 307 | Plural number of | 8 | 90 | 0.47 |
| | | circle, ring and | | | |
| | | fan shapes | | | |
| | 308 | Plural number of | 8 | 95 | 0.49 |
| | | circle, ring and | | | |
| | | fan shapes | | | |
| * | 309 | Plural number of | 8 | 120 | 2.60 |
| | | circle, ring and | | | |
| | | fan shapes | | | |

Mark * shows Examples other than invention of present application

With respect to the sample No. 301, since the ratio of L1/L2 was too little at 20%, the temperature difference of a wafer was large at 1.2° C.

Further, with respect to the sample No. 309, since the ratio of L1/L2 was too large at 120%, the temperature difference of a wafer was large at 2.6° C.

On the other hand, the temperature difference of a wafer was little at 0.5° C. or less in the samples No. 302 to No. 308 in which a distance between a pair of arc-shaped ends which were situated at the same circumference is smaller than a distance between arc-shaped patterns which are adjacent to a radial direction, and they show superior property.

Further, with respect to the samples No. 303 to 305, the ratio of L1/L2 was 40 to 60%, the temperature difference of a wafer was little at 0.39° C. or less and it was cleared that they are further superior.

### EXAMPLE 8

Plate-shaped ceramic bodies were prepared in the same manner as Example 7.

Further, the aluminum nitride sintered bodies were polished, a plural number of sheets of the disc-shaped ceramic bodies 2 with a plate thickness of 3 mm and a diameter of 315 mm to 330 mm were prepared and further, three penetration holes were equally formed on a concentric circle at a distance of 60 mm from the center. The diameter of the penetration holes were 4 mm.

Then, in order to paste the resistance exothermic bodies 5 on the plate-shaped ceramic bodies 2, an electroconductive paste which was prepared by kneading an Au powder, a Pd powder and a glass paste to which a binder comprising the fore-mentioned similar composition was added was printed in a fixed pattern by a screen printing method and then heated at 150° C. to dry an organic solvent, it was treated with the removal processing of fat at 550° C. for 30 minutes and calcination at a temperature of 700 to 900° C. was carried out to form resistance exothermic bodies 5 with a thickness of 50 μm.

The pattern arrangement of the resistance exothermic body zones 4 was the compositions of the 8 resistance exothermic body zones in total in which a resistance exothermic body zone was formed at one circle with a diameter D1 (mm) at the central portion, a resistance exothermic body zone was formed at a circular ring at its outside, a circular ring whose outer diameter was D2 (mm) was divided into two resistance exothermic body zones at its outside, and further, a circular ring whose inner diameter was D3 of the resistance exothermic body zone at the outermost periphery was divided into four resistance exothermic body zones. Then, the diameter of the outer contact circle C of the four resistance exothermic body zones at the outermost periphery was set as 310 mm and samples whose ratios of D1, D2 and D3 were changed were prepared. Then, the plate-shaped ceramic bodies 2 were prepared by soldering the electric power supply portions 6 on the resistance exothermic bodies 5 to be fixed. Further, in the present Example, the resistance exothermic body at the central portion and the circular ring-shaped exothermic bodies at its outside were simultaneously heated to be controlled.

Further, there was prepared the sample No. 336 having the resistance exothermic body zones of the composition in FIG. 21 for comparison in which the size of a rectangular resistance exothermic body zone was 212×53 mm and 8 rectangular resistance exothermic body zones were used. Similarly, the sample No. 337 was set as that the resistance exothermic body zones were the composition shown in FIG. 20, D1r was 150 mm and D2r was 310 mm. The sample No. 338 was set as the shape of the resistance exothermic body zones of the composition shown in FIG. 19. The sample No. 339 prepared a ceramic heater in which the resistance exothermic body zone was circular and comprised one resistance exothermic body.

Further, the thickness of the bottom face of a metal case having a bottom comprised aluminum of 2.0 mm and aluminum of 1.0 mm composing a side wall portion, and gas jetting orifices, a thermocouple and conduction terminals were installed at fixed positions on the bottom face. Further, a distance from the bottom face to the plate-shaped ceramic body was 20 mm.

Then, the plate-shaped ceramic body was overlapped on the opening portion of the metal case having a bottom, bolts were penetrated at the outer peripheral portion, a ring-shaped contact member was let intervene so that the plate-shaped ceramic body and the metal case having a bottom were not directly brought in contact, an elastic body was let intervene from the contact member side and nuts were screwed to prepare a ceramic heater.

Further, the section of the contact member 17 is L-character shaped and ring-shaped. With respect to the size of the L-character shaped section, the width of the contact face with the plate-shaped ceramic body was 3 mm. Further, a thermal resistant resin was used as the material of the contact member. The various ceramic heaters prepared were referred to as the samples No. 311 to No. 339.

The evaluation of the ceramic heaters prepared was carried out using the wafer for measuring temperature with a diameter of 300 mm in which the resistance temperature measuring elements were buried at 29 spots. Electric power sources were installed to the respective ceramic heaters, the temperature of the wafer W was raised from 25° C. to 200° C. for 5 minutes, the wafer W was removed after setting the temperature of the wafer W at 200° C., the wafer W for measuring temperature at room temperature was mounted on the wafer heating face, and measurement was carried out by setting a time until the average temperature of the wafer W was constant at a range of 200° C.±0.5° C. as a response time. Further, after the temperature cycle in which temperature was raised from 30° C. to 200° C. for 5 minutes and then the temperature was retained for 5 minutes and cooled for 30 minutes was repeated by 1000 cycles, it was set from room temperature to 200° C., and measurement was carried out setting the difference between the maximum value and the minimum value of the wafer temperature after 10 minutes, as the temperature difference of the wafer W.

Respective results are as shown in Table 8.

TABLE 8

| | | Number of | | | | | |
|---|---|---|---|---|---|---|---|
| | | resistance | | | | Temperature | Response |
| Sample | Composition of resistance | exothermic | D1/D × 100 | D2/D × 100 | D3/D × 100 | difference of | time |
| No. | exothermic body zones | body zones | (%) | (%) | (%) | wafer (° C.) | (sec.) |
| 311 | Plural number of circular | 8 | 18 | 48 | 75 | 0.48 | 43 |
| | ring and fan shapes | | | | | | |
| 312 | Plural number of circular | 8 | 20 | 48 | 75 | 0.39 | 35 |
| | ring and fan shapes | | | | | | |
| 313 | Plural number of circular | 8 | 23 | 48 | 75 | 0.28 | 28 |
| | ring and fan shapes | | | | | | |
| 314 | Plural number of circular | 8 | 27 | 48 | 75 | 0.27 | 27 |
| | ring and fan shapes | | | | | | |
| 315 | Plural number of circular | 8 | 30 | 48 | 75 | 0.38 | 34 |
| | ring and fan shapes | | | | | | |
| 316 | Plural number of circular | 8 | 35 | 48 | 75 | 0.42 | 38 |
| | ring and fan shapes | | | | | | |
| 317 | Plural number of circular | 8 | 40 | 48 | 75 | 0.43 | 39 |
| | ring and fan shapes | | | | | | |
| 318 | Plural number of circular | 8 | 25 | 48 | 75 | 0.49 | 45 |
| | ring and fan shapes | | | | | | |
| 319 | Plural number of circular | 8 | 25 | 40 | 75 | 0.42 | 39 |
| | ring and fan shapes | | | | | | |
| 320 | Plural number of circular | 8 | 25 | 41 | 75 | 0.38 | 33 |
| | ring and fan shapes | | | | | | |
| 321 | Plural number of circular | 8 | 25 | 43 | 75 | 0.29 | 28 |
| | ring and fan shapes | | | | | | |
| 322 | Plural number of circular | 8 | 25 | 45 | 75 | 0.28 | 27 |
| | ring and fan shapes | | | | | | |
| 323 | Plural number of circular | 8 | 25 | 49 | 75 | 0.29 | 28 |
| | ring and fan shapes | | | | | | |
| 324 | Plural number of circular | 8 | 25 | 53 | 75 | 0.39 | 34 |
| | ring and fan shapes | | | | | | |
| 325 | Plural number of circular | 8 | 25 | 55 | 75 | 0.41 | 39 |
| | ring and fan shapes | | | | | | |
| 326 | Plural number of circular | 8 | 25 | 60 | 75 | 0.46 | 44 |
| | ring and fan shapes | | | | | | |
| 327 | Plural number of circular | 8 | 25 | 48 | 50 | 0.49 | 45 |
| | ring and fan shapes | | | | | | |
| 328 | Plural number of circular | 8 | 25 | 48 | 55 | 0.42 | 39 |
| | ring and fan shapes | | | | | | |
| 329 | Plural number of circular | 8 | 25 | 48 | 60 | 0.41 | 38 |
| | ring and fan shapes | | | | | | |
| 330 | Plural number of circular | 8 | 25 | 48 | 65 | 0.37 | 33 |
| | ring and fan shapes | | | | | | |
| 331 | Plural number of circular | 8 | 25 | 48 | 67 | 0.22 | 26 |
| | ring and fan shapes | | | | | | |
| 332 | Plural number of circular | 8 | 25 | 48 | 70 | 0.23 | 28 |
| | ring and fan shapes | | | | | | |
| 333 | Plural number of circular | 8 | 25 | 48 | 80 | 0.38 | 33 |
| | ring and fan shapes | | | | | | |
| 334 | Plural number of circular | 8 | 25 | 48 | 85 | 0.38 | 34 |
| | ring and fan shapes | | | | | | |
| 335 | Plural number of circular | 8 | 25 | 48 | 90 | 0.45 | 48 |
| | ring and fan shapes | | | | | | |
| 336 | Rectangular shape | 8 | — | — | — | 2.40 | 63 |
| 337 | Conventional single | 5 | — | — | — | 1.80 | 55 |
| | circular ring | | | | | | |
| 338 | Fan shape | 4 | — | — | — | 2.50 | 73 |
| 339 | Single circular shape | 1 | — | — | — | 3.60 | 75 |

In the ceramic heater 1 of the invention of present application, the ceramic heaters of the samples No. 311 to No. 335, which were equipped with a circular resistance exothermic body zone at the central portion and resistance exothermic body zones within 3 concentric circular rings at its outside, were superior in that the temperature difference of the wafer W was less than 0.5° C. and response time was 48 seconds or less. Further, the ceramic heaters 1, in which the outer diameter D1 of the resistance exothermic body zone at the central portion was 20 to 40% of the outer diameter D of the resistance exothermic body zone at the outermost periphery, the outer diameter D2 was 40 to 55% of the outer diameter D and the outer diameter D3 was 55 to 85% of the outer diameter D, were the samples No. 312 to No. 317, No. 319 to No. 325 and No. 328 to No. 334 shown in table 8, and the temperature difference of the wafer W was little at 0.43° C. or less and further, a response time was little at 39 seconds or less. It was cleared that they show superior property.

Further, in the ceramic heaters of the samples No. 312 to No. 315 in which the outer diameter D1 of the resistance exothermic body zone at the central portion was 20 to 30% of the outer contact circle D of the resistance exothermic body zone, the temperature difference of the wafer W was little at 0.39° C. or less and further, a response time was little at 35 seconds or less. It was cleared that they were superior. Further, in the ceramic heaters of the samples No. 313 and No. 314 in which the outer diameter D1 was 23 to 27% of D, the temperature difference of the wafer was little at 0.28° C. or less and a response time was little at 28 seconds or less. It was cleared that they were further preferable.

Further, in the ceramic heaters of the samples No. 320 to No. 324 in which the outer diameter D2 was 41 to 53% of D, the temperature difference of the wafer W was little at 0.39° C. or less and a response time was little at 34 seconds or less. It was cleared that they were preferable. Further, in the ceramic heaters of the samples No. 321 to No. 323 in which the outer diameter D2 was 43 to 49% of D, the temperature difference of the wafer was little at 0.29° C. or less and a response time was little at 28 seconds or less. It was cleared that they were further preferable.

Further, in the ceramic heaters of the samples No. 328 to No. 334 in which the outer diameter D3 is 55 to 85% of D, the temperature difference of the wafer was little at 0.42° C. or less and a response time was little at 39 seconds or less. It was cleared that they were preferable. Further, in the ceramic heaters of the samples No. 330 to No. 334 in which the outer diameter D3 was 65 to 85% of D, the temperature difference of the wafer was little at 0.38° C. or less and a response time was little at 34 seconds or less. It was cleared that they were further preferable. Further, in the ceramic heaters of the samples No. 331 and No. 332 in which the outer diameter D3 was 67 to 70% of D, the temperature difference of the wafer was little at 0.23° C. or less and a response time was little at 28 seconds or less. It was cleared that they were further preferable.

To the contrary, in the samples No. 336 to No. 339 which were out of the present invention, the temperature difference of the wafer was large at 1.8° C. or more and a response time was large at 55 seconds or more. It was cleared that they were not preferable.

### EXAMPLE 9

Plate-shaped ceramic bodies were prepared in the same manner as Example 8.

Further, the aluminum nitride sintered bodies were polished, a plural number of sheets of the disc-shaped and plate-shaped ceramic bodies 2 with a plate thickness of 3 mm and a diameter of 315 mm to 345 mm were prepared and further, three penetration holes were equally formed on a concentric circle at a distance of 60 mm from the center. The diameter of the penetration holes were 4 mm.

Then, in order to paste the resistance exothermic bodies 5 on the plate-shaped ceramic bodies 2, an electroconductive paste which was prepared by kneading an Au powder, a Pd powder and a glass paste to which a binder comprising the fore-mentioned similar composition was added was printed in a fixed pattern by a screen printing method and then heated at 150° C. to dry an organic solvent, it was treated with the removal processing of fat at 550° C. for 30 minutes and calcination at a temperature of 700 to 900° C. was carried out to form resistance exothermic bodies 5 with a thickness of 50 μm. The pattern arrangement of the resistance exothermic body 5 was the compositions of the 8 resistance exothermic body zones in total in which it was radially divided into a circle and circular rings from the central portion, the pattern is formed on one circle at the central portion, a circular ring-shaped resistance exothermic body zone was formed at its outside, two resistance exothermic bodies were provided at a circular ring-shaped portion at its outside, and further, four patterns were provided at its outermost periphery. Then, the diameter of the outer contact circle C of the four resistance exothermic bodies at the outermost periphery was set as 310 mm and samples were prepared by changing the diameter of the plate-shaped ceramics. Then, the plate-shaped ceramic bodies 2 were prepared by soldering the electric power supply portions 6 on the resistance exothermic bodies 5 to be fixed.

Further, the thickness of the bottom face of a metal case having a bottom comprised aluminum of 2.0 mm and aluminum of 1.0 mm composing a side wall portion, and gas jetting orifices, a thermocouple and conduction terminals were installed at fixed positions on the bottom face. Further, a distance from the bottom face to the plate-shaped ceramic body was 20 mm.

Then, the plate-shaped ceramic bodies were overlapped on the opening portion of the metal case having a bottom, bolts were penetrated at the outer peripheral portion, a ring-shaped contact member same as the sample No. 301 was let intervene so that the plate-shaped ceramic body and the metal case having a bottom were not directly brought in contact, an elastic body was let intervene from the contact member side and nuts were screwed to prepare a ceramic heater.

The ceramic heaters prepared were evaluated in the same manner as Example 7.

Respective results are as shown in Table 9.

TABLE 9

| | | Ratio of diameter of outer | | |
|---|---|---|---|---|
| | | contact circle of the resistance | | |
| | | exothermic body zone 5 to | Temperature | |
| | Sample | diameter of plate-shaped | difference of | Response |
| | No. | ceramic body 2 (%) | wafer (° C.) | time (sec.) |
| | 345 | 85 | 0.48 | 35 |
| ◯ | 346 | 90 | 0.28 | 29 |
| ◯ | 347 | 92 | 0.16 | 25 |
| ◯ | 348 | 93 | 0.16 | 24 |
| ◯ | 349 | 95 | 0.16 | 25 |
| ◯ | 350 | 96 | 0.24 | 27 |
| ◯ | 351 | 97 | 0.26 | 28 |
| | 352 | 99 | 0.42 | 32 |

The mark ◯ is superior in property in particular.

Further, in the sample No. 345 of Table 9, the ratio of the outer contact circle of the resistance exothermic body to the diameter of the plate-shaped ceramic body was little at 85%, the temperature difference of the wafer was large as 0.48° C. and further, and a response time was slightly large at 35 seconds in particular.

Further, in the sample No. 352, it was cleared that the ratio of the outer contact circle of the resistance exothermic body to the diameter of the plate-shaped ceramic body was large at 99%, the temperature difference of the wafer was slightly large at 0.42° C. and a response time was also slightly large at 32 seconds.

Further, in the samples No. 346 to No. 351, since the temperature difference in the face of the wafer was little at 0.28° C. or less, further a response time was also little at 29 seconds or less and they were superior, it was cleared that a ceramic heater in which the ratio of the outer contact circle of the resistance exothermic body to the diameter of the plate-shaped ceramic body was 90 to 97% was a superior one.

### EXAMPLE 10

Plate-shaped ceramic bodies were prepared in the same manner as Example 7.

However, those in which the printing thickness of the paste was 20 μm and the ratio of area which the resistance exothermic body occupied to the outer contact circle surrounding the resistance exothermic body was changed were prepared.

Evaluation was carried out in the same manner as Example 7. The results are as shown in Table 10.

TABLE 10

| | | Ratio of area which above-mentioned | |
|---|---|---|---|
| | | belt shaped resistance exothermic | |
| | | body 5 occupies to outer contact | Temperature |
| | | circle C surrounding belt-shaped | difference |
| | Sample No. | resistance exothermic body 5 (%) | of wafer (° C.) |
| | 360 | 3 | 0.35 |
| ◯ | 361 | 5 | 0.24 |
| ⊚ | 362 | 10 | 0.19 |
| ⋆ | 363 | 15 | 0.13 |
| ⋆ | 364 | 20 | 0.12 |
| ⊚ | 365 | 25 | 0.18 |
| ◯ | 366 | 30 | 0.23 |
| | 367 | 40 | 0.34 |

As a result, as the sample No. 360, in case of a sample in which the ratio of area which the resistance exothermic body occupied to the outer contact circle surrounding the resistance exothermic body was lower than 5%, the temperature difference in the face of a wafer was slightly large at 0.35° C. Further, as the sample No. 367, when the ratio of area which the resistance exothermic body occupied to the outer contact circle surrounding the resistance exothermic body exceeds 30%, hot areas at which temperature was high appeared at the portion of the wafer and the temperature difference in the face of the wafer was slightly large at 0.34° C.

To the contrary, as shown in the samples No. 361 to 366, samples in which the ratio of area which the resistance exothermic body occupied to the outer contact circle of the resistance exothermic body was 5 to 30% were superior because the temperature difference in the face of a wafer could be little at 0.24° C. or less.

Further, as the samples No. 362 to No. 365, the temperature difference in the face of a wafer could be within 0.19° C. by setting the ratio of area which the resistance exothermic body occupied to the outer contact circle surrounding the resistance exothermic body as 10 to 25%, and further, as the samples No. 363 and No. 364, the temperature difference in the face of a wafer could be reduced within 0.13° C. by setting the ratio of area which the resistance exothermic body occupied to the outer contact circle surrounding the resistance exothermic body as 15 to 20%. It was cleared that they were superior in particular.

### BRIEF DESCRIPTION OF THE DRAWINGS

FIG. 1 is a section view showing one example of the ceramic heater of the present invention.

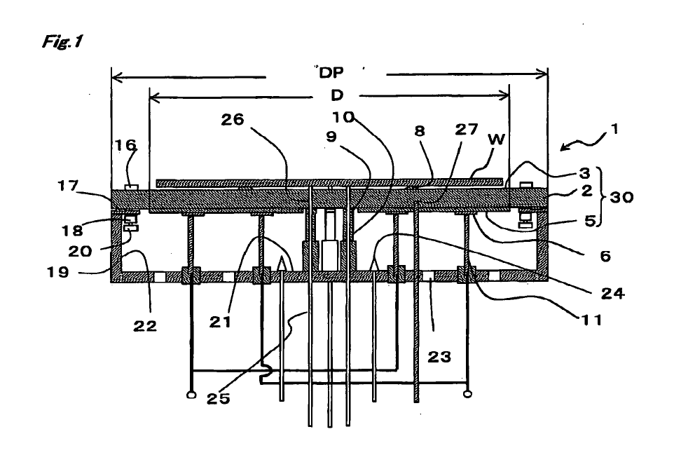

FIG. 2 is a magnified view showing the interval of the resistance exothermic body and the plate-shaped ceramic body of FIG. 1.

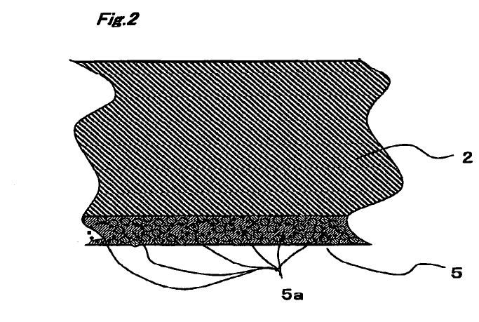

FIG. 3 is a magnified view of the resistance exothermic body of FIG. 2.

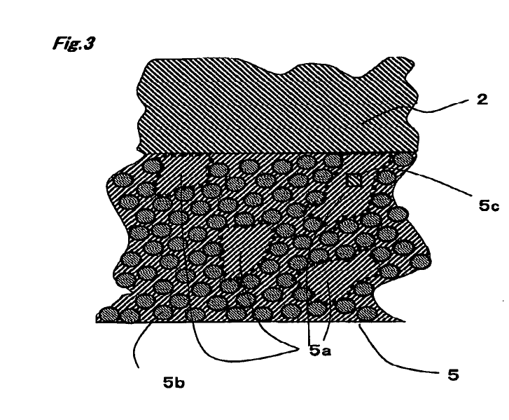

FIG. 4 is a magnified view showing the interval of the resistance exothermic body and the plate-shaped ceramic body of FIG. 1.

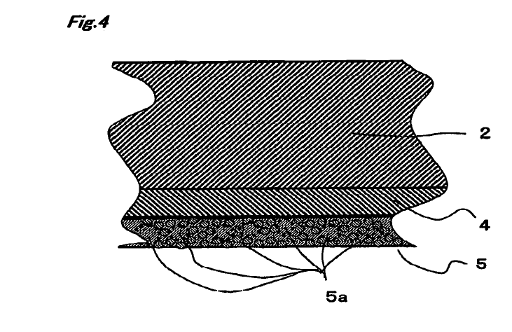

FIG. 5 is a magnified view showing the interval of the resistance exothermic body and the plate-shaped ceramic body of other ceramic heater of the present invention.

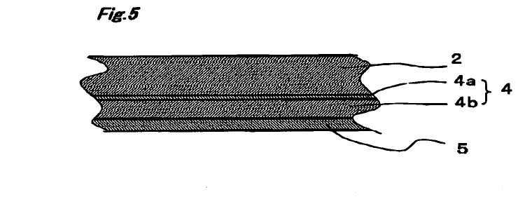

FIG. 6 is a section view showing other ceramic heater of the present invention.

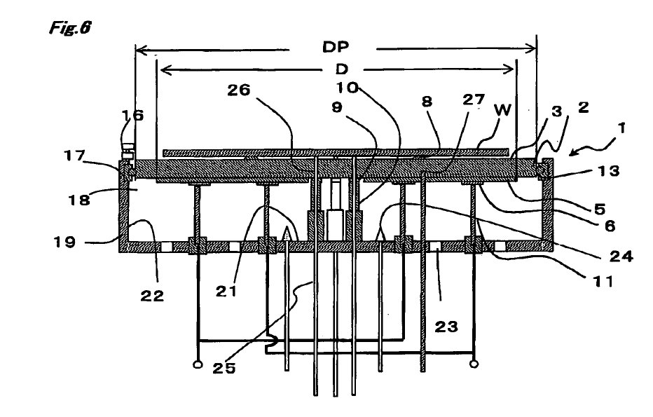

FIG. 7 is a view showing the resistance exothermic body of the ceramic heater of the present invention.

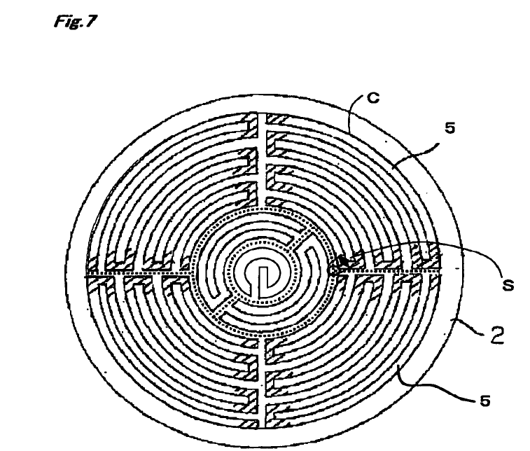

FIG. 8 is a view showing other resistance exothermic body of the ceramic heater of the present invention.

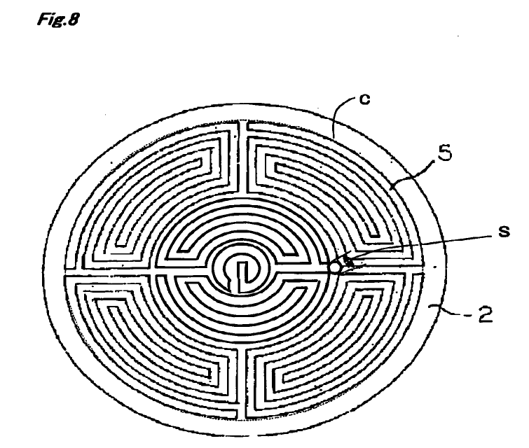

FIG. 9 is a section view showing the surrounding of the contact member of the ceramic heater of the present invention.

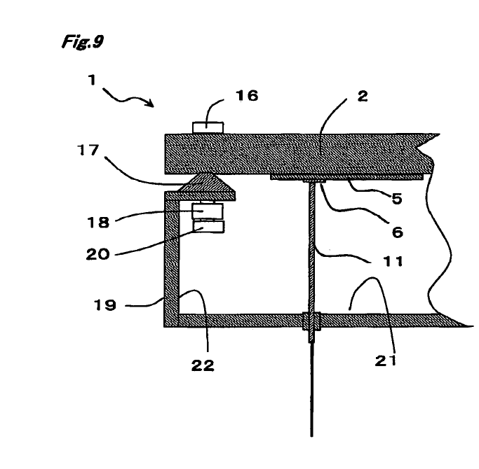

FIG. 10 is a section view showing the surrounding of other contact member of the ceramic heater of the present invention.

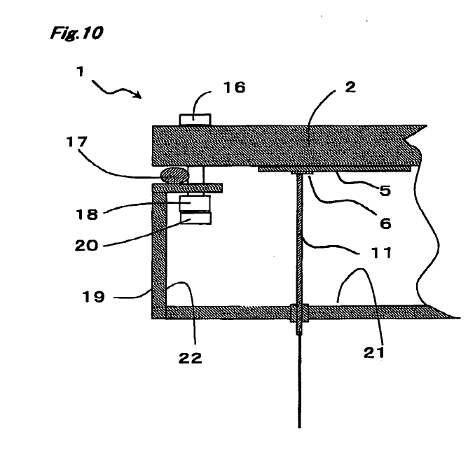

FIG. 11 is a section view showing a conventional ceramic heater.

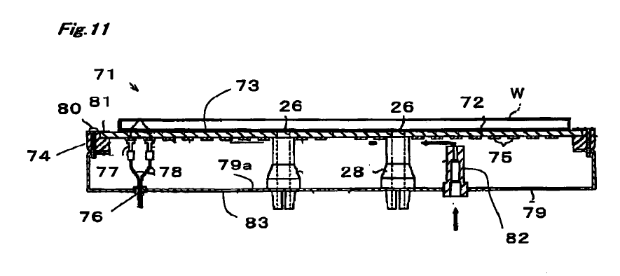

FIG. 12 is a view showing the resistance exothermic body of a conventional ceramic heater.

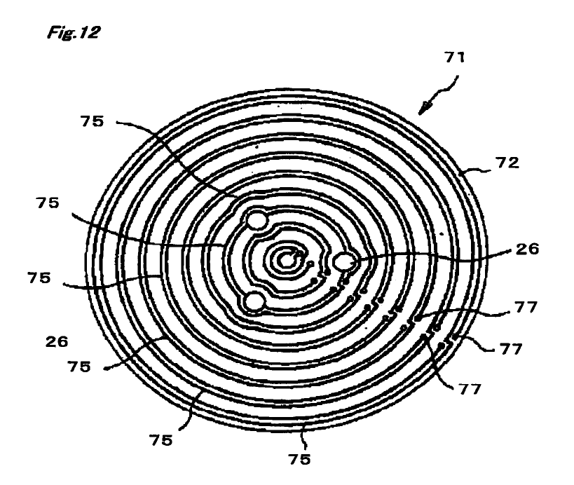

FIG. 13(a) is a section view showing the ceramic heater of the present invention. FIG. 13(b) is a magnified view showing the interval of the resistance exothermic body and the plate-shaped ceramic body of FIG. 13(a).

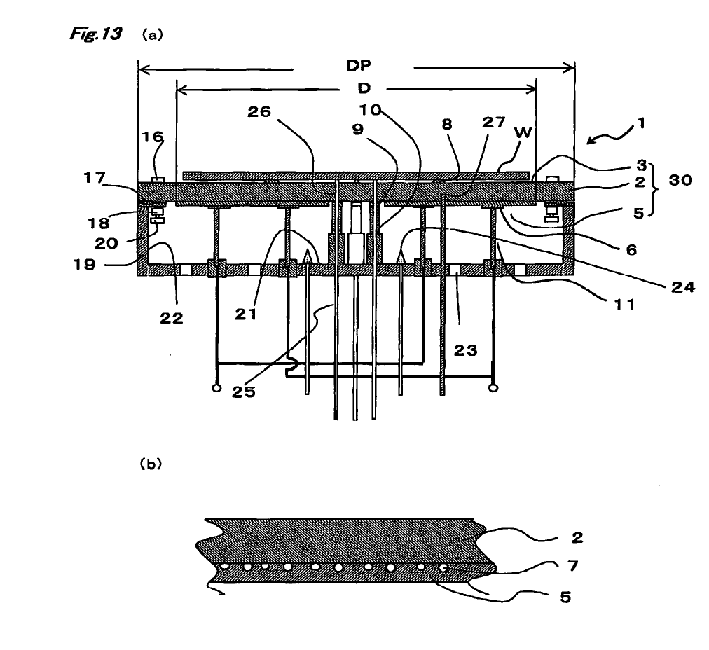

FIG. 14(a) is a section view showing other ceramic heater of the present invention. FIG. 14 (b) is a magnified view showing the interval of the resistance exothermic body and the plate-shaped ceramic body of FIG. 14 (a).

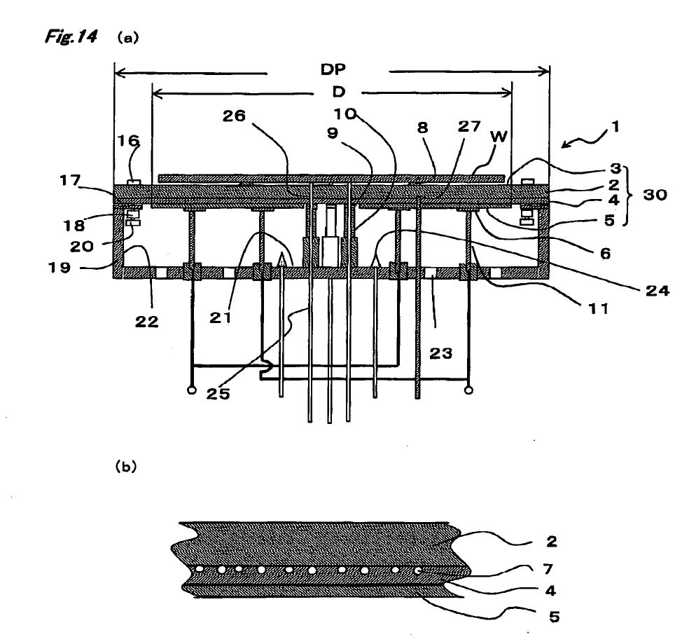

FIG. 15 is a magnified view showing the interval of the resistance exothermic body and the plate-shaped ceramic body of other ceramic heater of the present invention.

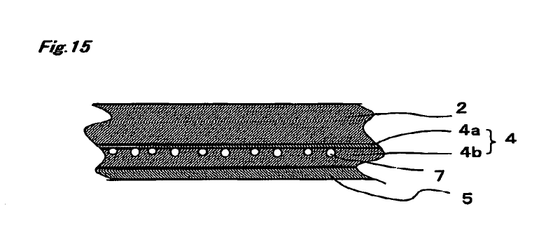

FIG. 16 is a schematic view showing the shape of the resistance exothermic bodies of the present invention.

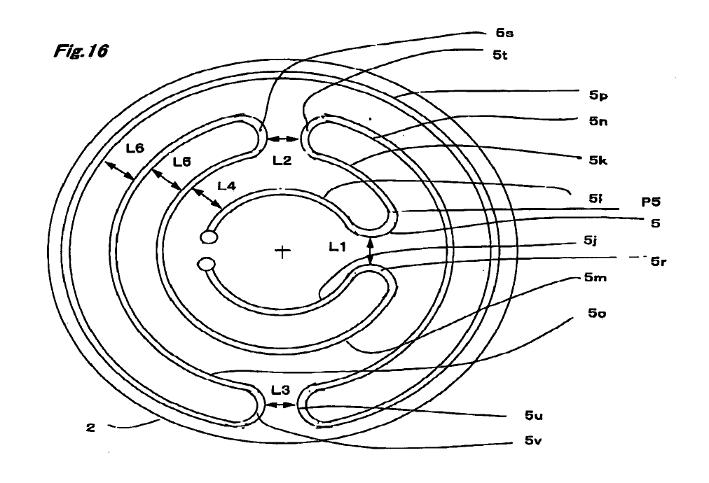

FIGS. 17 (a) and (b) are schematic views showing the shape of the resistance exothermic body zones of the present invention.

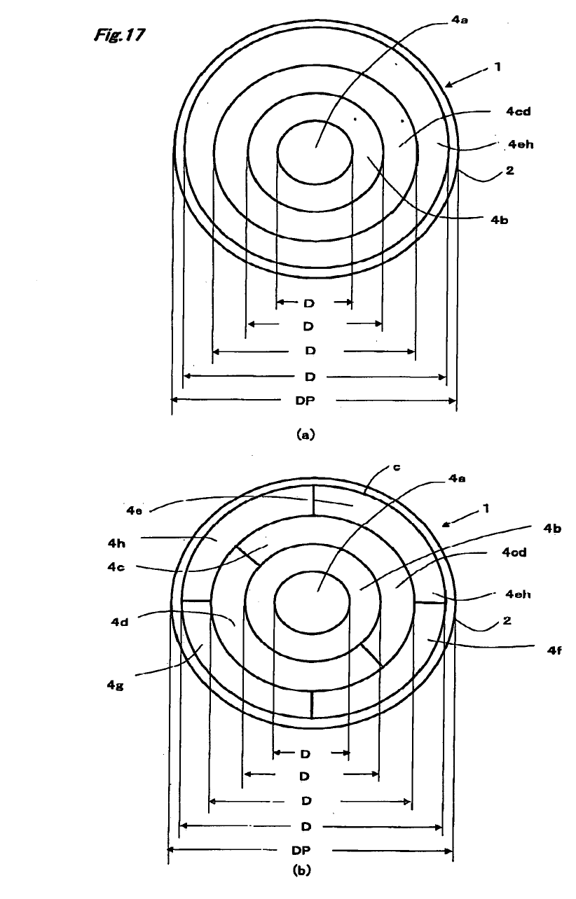

FIG. 18 is a schematic view showing the shape of the resistance exothermic bodies of the present invention.

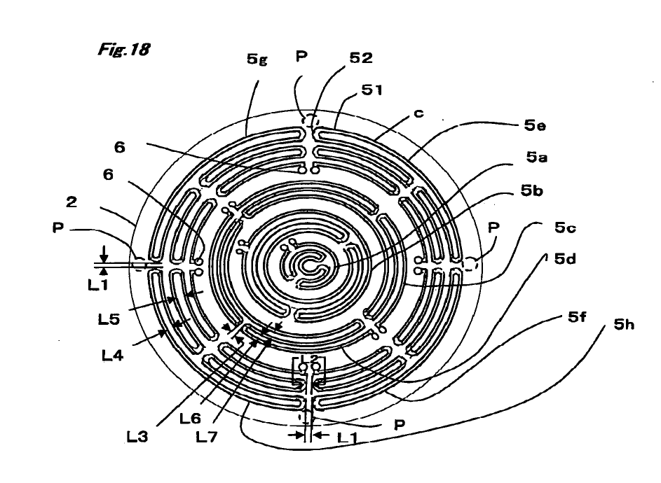

FIG. 19 is a schematic view showing the shape of conventional resistance exothermic bodies.

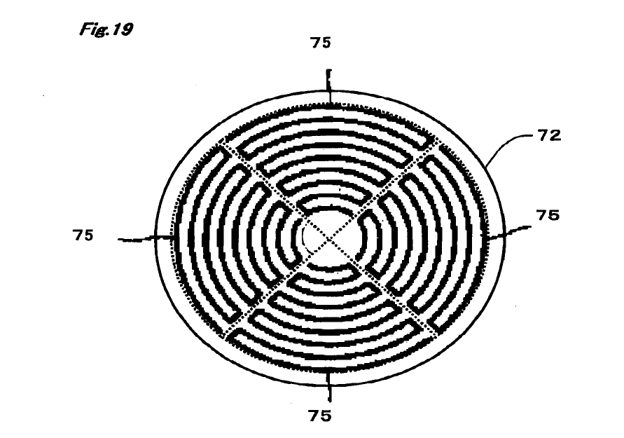

FIG. 20 is a schematic view showing the shape of conventional other resistance exothermic bodies.

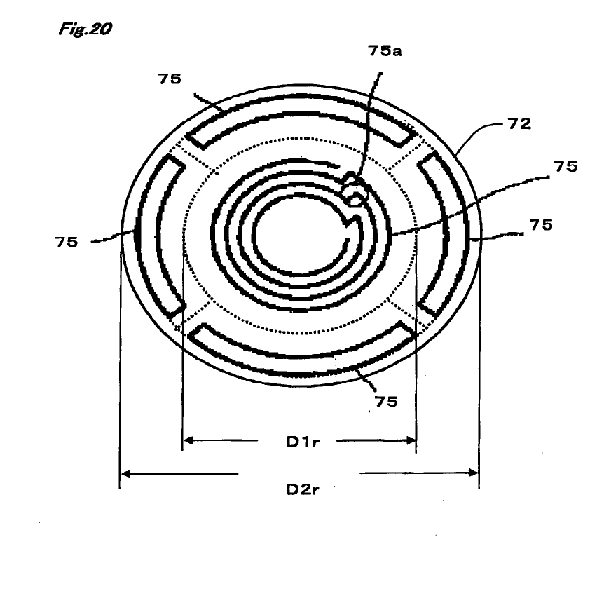

FIG. 21 is a schematic view showing the shape of conventional other resistance exothermic bodies.

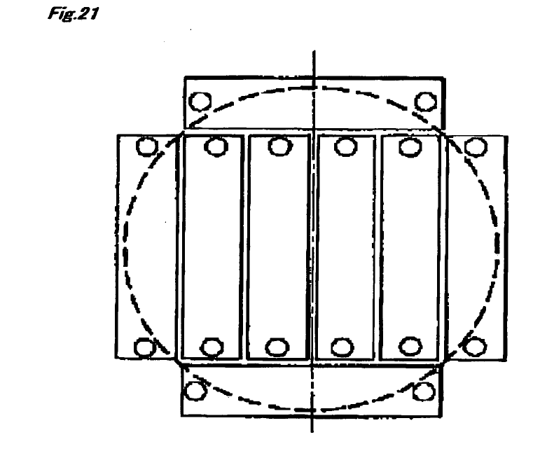

### REFERENCE NUMERALS

1, 71: ceramic heater, wafer heating device
2, 72: a plate-shaped ceramic body
3, 73: wafer heating side
4: insulating layer
5, 75: resistance exothermic body
5a: lumps of the insulating composition
5b: electroconductive particles
5c: particles
6: electric power supply portions
7: pores
8: supporting pins
11, 77: a power supply terminal
10, 12: guide members
16: bolt
17: connecting members
18: elastic body
19, 79: metal case
20: nuts
21: under face
23: discharge holes
24: nozzle
25: wafer lift pins
26: through holes
27: thermo couple
28: guide members
29, 79: case
W: semiconductor wafer

1-27. (canceled)

28. A ceramic heater which comprises plate-shaped ceramic body having a pair of main surfaces, one of which is used for heating; and belt-shaped resistance exothermic bodies provided at the other surface or the inside of the plate-shaped ceramic body,
wherein the belt-shaped resistance exothermic bodies comprises an insulating composition and electroconductive particles in a manner to make lumps of the insulating composition surrounded by a lot of the electroconductive particles.

29. The ceramic heater according to claim 28, wherein the mean diameter of the lumps of the insulating composition is 3-fold or more of the mean diameter of the electroconductive particles.

30. The ceramic heater according to claim 28, wherein the mean diameter of the electroconductive particles is in a range of 0.1 to 5 μm and the mean diameter of the lumps of the insulating composition is in a range of 3 to 100 μm.

31. The ceramic heater according to claim 28, wherein particles having a larger thermal expansion coefficient than that of the insulating composition are provided internally in the lumps of the insulating composition.

32. The ceramic heater according to claim 31, wherein the particles having a large thermal expansion coefficient is of the same composition as the electroconductive particles.

33. The ceramic heater according to claim 31, wherein an area rate occupied by the particles contained in the lumps of the insulating member is 10% or less at a cross-section.

34. A ceramic heater which comprises plate-shaped ceramic body having a pair of main surfaces, one of which is used for heating; and belt-shaped resistance exothermic bodies provided at the other surface or the inside of the plate-shaped ceramic body,
wherein pores are formed in the resistance exothermic bodies along an interface between the plate-shaped ceramic body and the resistance exothermic bodies.

35. A ceramic heater which comprises plate-shaped ceramic body having a pair of main surfaces, one of which is used for heating; and belt-shaped resistance exothermic bodies provided at the other surface or the inside of the plate-shaped ceramic body,
wherein pores are formed in the insulating layer along the interface between the plate-shaped ceramic body and the insulating layer.

36. The ceramic heater according to claim 34, wherein the size of the pores is 0.05 to 50 μm.

37. The ceramic heater according to claim 35, wherein the size of the pores is 0.05 to 50 μm.

38. The ceramic heater according to claim 34, wherein the line density of the pores is in a range of 1,000 to 500,000/m at a cross-section which is perpendicular to the main face of the plate-shaped ceramic body.

39. The ceramic heater according to claim 35, wherein the line density of the pores is in a range of 1,000 to 500,000/m at a cross-section which is perpendicular to the main face of the plate-shaped ceramic body.

40. A ceramic heater which comprises plate-shaped ceramic body having a pair of main surfaces, one of which is used for heating; and belt-shaped resistance exothermic bodies provided at the other surface or the inside of the plate-shaped ceramic body,
wherein the resistance exothermic bodies comprise electroconductive particles and an insulating composition in a manner to make parallel arc-shaped belts having about the same width provided with arc-shaped ends connecting two belts so as to be formed in a nearly concentrical circle and to have a distance between a pair of arc-shaped ends situated on the same circle, which is smaller than a distance between arc-shaped belts which are adjacent to a radial direction.

41. The ceramic heater according to claim 40, wherein the distance between a pair of the arc-shaped ends which are situated on the same circle is 30% to 80% of the distance between the arc-shaped belts which are adjacent to a radial direction.

42. The ceramic heater according to claim 40, wherein a plural number of the belt-shaped resistance exothermic bodies can be independently heated, at least one of the resistance exothermic bodies having the distance between a pair of the arc-shaped ends which are situated on the same circle smaller than the distance between the arc-shaped patterns which are adjacent to a radial direction.

43. The ceramic heater according to claim 40, wherein the resistance exothermic bodies comprise a zone of circular resistance exothermic body at a central portion and a zone of three concentric circular ring-shaped resistance exothermic bodies at the outside.

44. The ceramic heater according to claim 43, wherein the outer diameter D1 of the resistance exothermic body zone at a central portion is 20 to 40% of the outer diameter D of the outermost peripheral resistance exothermic body zone, the outer diameter D2 of the resistance exothermic body zone at its outer side is 40 to 55% of the outer diameter D, and the outer diameter D3 of the resistance exothermic body zone at its outer side is 55 to 85% of the outer diameter D of the outermost peripheral resistance exothermic body zone.

45. The ceramic heater according to claim 43, wherein among the three circular ring-shaped resistance exothermic body zones, the innermost resistance exothermic body zone is an independent resistance exothermic body and equipped with a circular ring-shaped resistance exothermic body at its outside, the resistance exothermic body zone at its outside is two areas which were obtained by equally dividing a circular ring into 2 portions to a circumferential direction, and the resistance exothermic body zone at its outside is four areas which were obtained by equally dividing a circular ring into four portions to a circumferential direction.

46. The ceramic heater according to claim 43, wherein penetration holes are provided in the plate-shaped ceramic body between the resistance exothermic body zone at a central portion and ring-shaped resistance exothermic bodies at its outside.

47. The ceramic heater according to claim 40, wherein the width of the belt of the outermost peripheral resistance exothermic body is smaller than the width of the belts of other resistance exothermic body zones at its inside.

48. The ceramic heater according to claim 40, wherein the area ratio of the resistance exothermic bodies occupied in the outer contact circle is 5 to 30% of the area of the outer contact circle surrounding the resistance exothermic body zones.

49. A wafer heating device which comprises the ceramic heater according to claim 28, wherein the plate-shaped ceramic body has a pair of main surfaces, one of which is a wafer heating face on which a wafer is mounted.

50. A wafer heating device which comprises the ceramic heater according to claim 34, wherein the plate-shaped ceramic body has a pair of main surfaces, one of which is a wafer heating face on which a wafer is mounted.

51. A wafer heating device which comprises the ceramic heater according to claim 35, wherein the plate-shaped ceramic body has a pair of main surfaces, one of which is a wafer heating face on which a wafer is mounted.

52. A wafer heating device which comprises the ceramic heater according to claim 40, wherein the plate-shaped ceramic body has a pair of main surfaces, one of which is a wafer heating face on which a wafer is mounted.

53. A method of preparing a semiconductor substrate which comprises steps of providing a semiconductor wafer mounted on a wafer heating face of the wafer heating device according to the claim 49; and
subjecting the semiconductor wafer to a semiconductor thin film treating, etching and resist film forming while the semiconductor wafer is heated on the wafer heating face.

54. A method of preparing a semiconductor substrate which comprises steps of providing a semiconductor wafer mounted on a wafer heating face of the wafer heating device according to the claim 50; and
subjecting the semiconductor wafer to a semiconductor thin film treating, etching and resist film forming while the semiconductor wafer is heated on the wafer heating face.

55. A method of preparing a semiconductor substrate which comprises steps of providing a semiconductor wafer mounted on a wafer heating face of the wafer heating device according to the claim 51; and
subjecting the semiconductor wafer to a semiconductor thin film treating, etching and resist film forming while the semiconductor wafer is heated on the wafer heating face.

56. A method of preparing a semiconductor substrate which comprises steps of providing a semiconductor wafer mounted on a wafer heating face of the wafer heating device according to the claim 52; and
subjecting the semiconductor wafer to a semiconductor thin film treating, etching and resist film forming while the semiconductor wafer is heated on the wafer heating face.
